(19) United States
(12) Patent Application Publication
(10) Pub. No.: US 2026/0226635 A1
(43) Pub. Date: Aug. 6, 2026

(54) CATALYST FOR ELECTROLYSIS

(71) Applicant: Royal Melbourne Institute of Technology, Melbourne (AU)

(72) Inventors: Nasir Mahmood, Melbourne (AU); Suraj Loomba, Melbourne (AU)

(21) Appl. No.: 19/150,667

(22) PCT Filed: Jan. 24, 2024
(86) PCT No.: PCT/AU2024/050042

§ 371 Date: Jul. 24, 2025

(30) Foreign Application Priority Data
Jan. 24, 2023 (AU) 2023900163

(51) Int. Cl. C25B 11/031; C25B 1/04; C25B 11/067

(52) U.S. Cl. CPC C25B 11/031; C25B 1/04; C25B 11/067

(57) ABSTRACT

The invention provides a heteroatom doped mixed metal molybdenum electrocatalyst for water electrolysis, as well as methods of make same and use of same in electrolytic cells. The electrocatalyst comprises at least one ultra-thin 2D defect rich porous sheet of crystalline inorganic material which is a heteroatom doped-transition metal molybdenum phosphide, wherein the transition metal is other than molybdenum, and wherein a plurality of pores and a plurality of other defects form active sites which are distributed laterally across the ultra-thin 2D porous sheet, that is, distributed between edges of the sheet.

### TECHNICAL FIELD

The invention relates to a bifunctional electrocatalyst for full water splitting, particularly alkaline water or seawater.

### BACKGROUND OF INVENTION

With net zero emissions, hydrogen has potential as an alternative clean fuel, but its dependency on electrolysis of freshwater threatens a sustainable environment. Commercial water electrolysis generally uses strongly acidic or alkaline electrolytes and expensive platinum group metal electrocatalysts to achieve the lowest onset potentials for the hydrogen evolution reaction (HER). While the theoretical potential of 1.23 V is required to drive electrolytic full water splitting, typically higher potentials of between 1.8 and 2.5 V are required to reach industrially practical current densities. The difference between the theoretical voltage and the experimentally required voltage is the overpotential, and may be defined for the overall reaction as well as for both half reactions. Aside from the energy inefficiency, electrolysis at such high overpotentials is susceptible to operational problems including electrocatalyst instability in alkaline electrolytes. Direct electrolysis/splitting of seawater, an unlimited source, is a desirable alternative, but during electrolysis, chlorine anions in seawater not only undesirably lead to chlorine evolution reaction (CER) competing with the oxygen evolution reaction (OER) on the anode, but also its salt rich and impure nature tends to corrode the electrodes, and thus expensive desalination is required. While the thermodynamic preference of OER over CER in alkaline electrolytes can suppress the CER, the formation of hypochlorite under alkaline conditions at overpotentials of >490 mV by chlorine interaction with OH⁻ is a challenge in attaining stable operation. Therefore, it is desirable to develop catalysts that can carry out OER at overpotentials <490 mV to avoid the formation of hypochlorite. Achieving an overall lower cell voltage in alkaline seawater is a real challenge due to complicated reaction kinetics for hydrogen evolution reaction (HER) over the cathode as the extra water dissociation step involved limits success (requires extra energy). Therefore, highly efficient and stable catalysts need to be developed, which can catalyze both OER and HER at extremely low overpotentials to realize seawater splitting under the potential limits that avoid CER.

Spherically shaped particles of a nitrogen-doped oxygenated molybdenum phosphide (N—MoP) have been reported as an electrocatalyst for hydrogen evolution in alkaline media producing a current density of 10 mA cm⁻² at a very low overpotential of 87 mV, which is much better than annealed nitrogen doped molybdenum oxide (A-MoOx) which requires an overpotential of 138 mV in alkaline medium. The N—MoP is generated via a hydrothermal method that results in nitrogen doping of the inorganic material, followed by annealing in a N₂ atmosphere and subsequent phosphorization to form the nitrogen doped oxygenated molybdenum phosphide (N—MoP) sphere-shaped structure. It is reported that N-MoP's efficiency for HER is attributed to a more exposed surface, a large electrode/electrolyte interface and appropriate binding energy for reactants. However, common with existing transition metal phosphide (TMP)-based catalysts, there are problems with maintaining this material's active site stability in seawater and there are accessibility issues and unstable active sites. Addressing these problems is not discussed in the prior art.

There is therefore an ongoing need for new electrocatalysts and methods of electrolysis which at least partially address one or more of the above-mentioned shortcomings, or at least provide a useful alternative.

### SUMMARY OF INVENTION

The present invention enables tuning known N-doped Mo₃P alkaline water/seawater electrolysis catalysts to optimise them for enhanced activity and stability in HER, OER and full water splitting reactions at ultra-low overpotentials, while avoiding competing CER in the case of sea water electrolysis.

The inventors have engineered improved TMP based catalysts to provide a highly effective, stable, alkaline water/seawater electrolysis catalyst that performs at previously unachievably low overpotentials in alkaline water and seawater. The new catalysts are heteroatom doped-transition metal-Mo phosphite materials provided as ultrathin 2D porous sheets, whereby each sheet comprises a plurality of pores and other defects (defect rich) located throughout the sheet, thereby making the entire sheet including the basal plane of each sheet electrochemically active. Further advantages of the invention arise from engineering the material to comprise active dangling bonds at edges of the pores distributed across the sheet, attenuated Mo oxidation/energy density through modulation with heteroatom dopants and inclusion of a further (non-Mo) metal in the phosphite core. Together, these features result in stable but highly reactive active sites and energy states that favour the electrolysis reactions, as well as providing a polyanion shield to repel contaminants and chloride anions, making the active sites selective, effective and stable even in seawater electrolyte.

As such, the inventors have now designed and prepared a heteroatom doped-transition metal (other than molybdenum)-molybdenum phosphite electrocatalyst for electrolysis which shows remarkable performance, whereby a preferred catalyst of the invention requires overpotentials of only 23 and 35 mV for the hydrogen evolution reaction in the electrolysis of alkaline water (e.g., 1.0 M KOH) and seawater, respectively. In other embodiments, the preferred catalysts are used as bifunctional catalysts for full water splitting at 1.52 and 1.55 V to achieve 10 mA cm⁻² in alkaline water (e.g., 1.0 M KOH, pH 14) and seawater, respectively, without production of any chorine as the CER is suppressed, due to the very low overpotential required for the OER and HER reactions as a result of the reduced activation barriers in the HER and OER pathways enabled by the catalysts of the invention. The catalysts described herein are effective in realizing low-cost hydrogen directly from alkaline water (e.g., 1.0 M KOH) and seawater.

The invention provides an electrocatalyst comprising at least one ultra-thin 2D defect rich porous sheet of a crystalline inorganic material which is a heteroatom doped-transition metal molybdenum phosphide, wherein the transition metal is other than molybdenum. Desirably, a plurality of pores and a plurality of other defects forming active sites are distributed laterally across the ultra-thin 2D porous sheet, that is, distributed, e.g., in areas or faces, between edges of the sheet.

In other words, the plurality of pores and a plurality of other defects are not confined to edges of the sheet, but rather are also provided laterally right across the entirety of the sheet, meaning the pores and defects are provided throughout a body of the sheet. In this way, significantly more defects and active sites are provided compared to a typical 2D ultra-thin catalytic sheet, which only has edge defects/active sites.

Suitably, the sheets may be regularly shaped, irregularly shaped or a combination of both. Desirably, the ultra-thin sheets are irregularly shaped, particularly in the broad/flat plane of the material, that is the micrometer dimension.

In a first aspect, the invention provides an electrocatalyst comprising at least one ultra-thin 2D defect rich porous sheet of a crystalline inorganic material which is a heteroatom doped-transition metal molybdenum phosphide, wherein the transition metal is other than molybdenum, and wherein a plurality of pores and a plurality of other defects form active sites which are distributed laterally across the ultra-thin 2D porous sheet, that is, are distributed between edges of the sheet.

Desirably, the plurality of pores and the plurality of other defects are distributed laterally across the ultra-thin 2D porous, that is, from a central line on the sheet extending outwardly towards sides/edges of the sheet. It will be understood that lateral distribution means the pores and defects are present throughout the entirety of the sheet and not just at the edges.

As the sheets are ultra-thin, in some embodiments, one or more, and in some cases, all of the plurality of pores go through a body of sheet, traversing the sheet's nanometer dimension. Desirably, defects, particularly those involving surface functional groups, are located on all faces of a sheet.

It will be understood that the sheets also comprise edge defects/active sites.

It is believed that the additional laterally distributed plurality of active site pores and plurality of other active site defects greatly enhance the material's catalytic activity.

The electrocatalysts of the invention are particularly effective in HER reaction, OER reaction and indeed full water splitting, in an electrochemical reaction involving alkaline water, and seawater as electrolyte, where advantageously they exhibit enhanced electrochemical activity (greatly reduced overpotential) while they resist the corrosion typically experienced in seawater, and are not involved in competing side reactions which occur due to its high salt content. Advantageously, the electrocatalyst of the invention is selective for OER over CER when seawater is used as electrolyte. This means that the materials avoid production of chlorine gas during electrolysis of seawater, which has a high chloride ion content. Further, the electrocatalysts of the invention provide remarkably efficient activity in alkaline water or seawater, where it has been demonstrated that a preferred example only requires overpotentials of 23 and 35 mV for hydrogen evolution reaction, and it catalyzes full water splitting at 1.52 and 1.55 V to achieve 10 mA cm⁻², in 1.0 M KOH and seawater, respectively.

The structural and compositional engineering described herein make the modified TMP catalysts of the invention effective in realizing low-cost hydrogen directly from seawater.

The electrocatalysts of the invention are believed to exhibit such favourable properties due to their unique engineering which provides a greatly enhanced number of active sites for catalysis. In particular, the introduction of large homogenous pores in the basal plane of the sheets (lateral distribution across the sheet between edges of the sheet) makes the materials catalytically more active and ensures faster mass transfer. The introduction of heteroatoms and (non-Mo) transition metals into the MoP structure significantly tunes the electronic density of Mo, surface chemistry, and metal-non-metal bond lengths, optimizing surface energies, creating new active sites, and increasing electrical conductivity. The presence of metal-heteroatom bonds and surface polyanions in the materials increases the stability and improves anti-corrosive properties against chlorine chemistry. Notably, the structure of the ultra-thin 2D defect rich porous sheet of crystalline inorganic material is retained after electrochemical use in seawater electrolyte, demonstrating the material's stability. In particular, the defects in the crystal structure caused by the pores, dangling bonds, bond polarity, grain boundaries and transition metal and hetero-atom doping are important electrochemically active sites. Further, the dangling bonds formed at the pore edges and further defects, for example, bond polarity introduced as a result of heteroatom, particularly nitrogen doping and the addition of transition metals, such as Ni, all lend to the excellent activity.

Preferably, the inorganic material is polycrystalline, that is, comprises a plurality of crystallites having at least one grain boundary defect at interfaces between adjacent crystallites. Since the structure is in a sheet format with a generally micron dimension face length, the sheet comprises a plurality of grain boundaries for active sites.

Preferably, each sheet has a basal plane/surface (the micron dimensioned portion of the sheet, as opposed to the nanometre dimensioned edge) comprising a plurality of defects, selected from one or more of grain boundaries, pores, heteroatom doping, and bond polarity, preferably wherein the defects are electrochemically active sites.

Preferably, each element, the plurality of pores and plurality of other defects that form active sites are homogenously distributed throughout an entire area, particular the largest face of the porous sheet. This is in contrast to other 2D ultrathin sheet catalytic materials which have edge active sites only, and none distributed across the entire surface area of the faces of the sheet. For example, the pore distribution can be determined by TEM analysis which demonstrates the presence of homogeneously distributed pores indicating the formation of highly porous sheets, across the entirety of the sheet structure.

Preferably, pores in the sheet have pore edges comprising electrochemically active dangling bond sites at the pore edges. The existence of dangling bonds at pores creates new active sites and provides easy access through open pathways for mass transfer. Similar to other 2D sheets, the edges of the sheet comprise electrochemically active dangling bond sites at the pore edges.

Preferably, the heteroatom doping, preferably nitrogen doping, occurs at grain boundaries. It is believed that annealing during production produces the defect-rich structure by tuning the chemistry at the crystallite grain boundaries by enriching the catalyst with active sites through grain boundary engineering and removing adsorbed species at dangling bonds present at pores and edges. The resulting extended electrode/electrolyte interface creates a foundation for an ideal catalyst for direct seawater splitting. The annealing provides the required energy to re-join the small sheets during formations to form larger sheets, introducing additional grain boundaries that will act as active sites with distinct energy differences and will be hotspots for water adsorption and hydrogen desorption.

Preferably, the heteroatom dopant is a heteroatom, particularly an electron withdrawing heteroatom, selected from one or more of: nitrogen, boron, sulfur and phosphorus, preferably boron and phosphorus, most preferably nitrogen. The metal-heteroatom bond is responsible for the anti-corrosive properties to overcome the harsh seawater environment. This is particularly the case for nitrogen dopants. Higher electronegativity of heteroatoms, particularly nitrogen (metal-nitrogen bonds), help in improving the stability of active sites through the electron-withdrawing capability and helping the metal atoms to obtain a higher valence state, hence improving the transfer of electrons and mobilizing the electronic density of the catalyst. Moreover, the metal-heteroatom, preferably metal-nitrogen bond, decreases the diffusion rate of any unwanted molecules/ions to the surface of the catalyst, decreasing the contact between the reactants and the seawater electrolyte. In short, the M-heteroatom bond, preferably M-N bond, increases the overall electrical conductivity, intrinsic activity, and anti-corrosive properties of the material.

In a particularly preferred embodiment, the heteroatom is nitrogen and the electrocatalyst is nitrogen doped-transition metal-molybdenum phosphide.

Preferably, the transition metal is, for example, a first-row transition metal, preferably selected from nickel (Ni), cobalt (Co), and iron (Fe), most preferably nickel (Ni). It is believed that the defects redistribute electrons and together with a synergistic effect between the transition metal and Mo in the materials of the invention which, in addition to heteroatom doping, tune the energy state of Mo for electrolysis. The presence of surface phosphate and nitrates collectively tune the surface for efficient water catalysis and protection from corrosive chlorine chemistry.

Preferably, the inorganic material comprises the transition metal in the (II) or (III) oxidation state, preferably nickel in the Ni²⁺ oxidation state, or iron in the Fe²⁺/Fe³⁺ oxidation state, for example, as determined by X-ray photoelectron spectroscopy.

Advantageously, the catalysts of the invention have numerous active sites, for example, at pores and other defect sites provided across the faces of each sheet of the material for efficient water catalysis as the presence of transition metal (non-Mo) and heteroatom dopants assist in the redistribution of Mo's electron densities, enhancing the electrical conductivity and tuning the metal-non-metal bond lengths. Furthermore, the addition of heteroatom dopant and non-Mo transition metal, preferably N and Ni or N and Fe, also makes the Mo species flexible during the oxidation-reduction cycles, which also enhances the adsorption of intermediates. The presence of neighbouring transition metal, e.g., Ni or Fe sites uplift the d-band centre of the Mo sites leading to a better transfer of electrons, and this rapid transfer of electrons is essential for improving the adsorption of intermediates and for better performance.

In short, the introduction of a heteroatom dopant and non-Mo transition metal, preferably N and Ni or N and Fe, changes the oxidation state and hence the electron densities of Mo as well as helps in tuning the metal-non-metal bond length.

Preferably, the inorganic material comprises a shield of one or more polyanions which repel negative anions, for example, chloride, from surfaces of the inorganic material, thereby reducing interference.

Preferably, the polyanions comprise one or more of: phosphate, nitrate and hydroxyl, for example as determined by X-ray photoelectric spectroscopy, FTIR and/or XPS analysis. The presence of polyanions on the surface (phosphate, sulfate and nitrate) safeguards the catalyst from chlorine chemistry. The phosphate, nitrate, and hydroxyl ions make a polyanion shield to form a protective coating on the surface. The presence of these polyanions on the surface of the catalyst is known to improve the cation selectivity and tends to repel and block the chloride anions. Thus, these polyanions play a crucial role in corrosion inhibition and in preventing chloride anions from reaching catalyst and corroding the underlying surface. It is believed that the presence of phosphate/nitrate and hydroxyl groups are useful to protect the catalyst from anion attack (chloride present in seawater) and optimize the surface for cation absorption.

Preferably, the pores comprise one or more of:
micropores, preferably of average pore diameter of from about 0.75 nm to about 1.20 nm, more preferably about 1 nm to about 1.3 nm, for example, as determined by Barrett-Joyner-Halenda (BJH) analysis of nitrogen adsorption/desorption isotherms; and
mesopores, preferably of average pore diameter of from about 2 nm to about 50 nm, more preferably about 5 nm to about 25 nm, for example, as determined by Barrett-Joyner-Halenda Halenda (BJH) analysis of nitrogen adsorption/desorption isotherms.

Preferably, the pores comprise a pore volume ranging from about 3.00×10⁻³ cm³ g⁻¹ to about 7.00×10⁻³ cm³ g⁻¹, more preferably from about 4.00×10⁻³ cm³ g⁻¹ to about 6.00×10⁻³ cm³ g⁻¹, and most preferably about 5.10×10⁻³ cm³ g⁻¹ in the case of a nitrogen doped-nickel molybdenum phosphide (N—NiMo₃P), for example, as determined by Barrett-Joyner-Halenda Halenda (BJH) analysis of nitrogen adsorption/desorption isotherms

The large homogenous pores are believed to lead to better mass transport and new active sites at the dangling bond sites of the pore edges, making the entire basal plane of the sheets active.

Preferably, the inorganic material has a surface area of greater than about 5.00 m² g⁻¹, preferably greater than about 12.50 m² g⁻¹, more preferably greater than about 15.00 m² g⁻¹, and most preferably about 19.29 m² g⁻¹ in the case of a nitrogen doped-nickel molybdenum phosphide (N—NiMo₃P), for example, as determined by Brunauer-Emmett-Teller (BET) analysis of nitrogen adsorption/desorption isotherms.

In a second aspect, the invention provides an electrocatalyst comprising at least one ultra-thin 2D defect rich porous sheet of a crystalline inorganic material which is a nitrogen doped-transition metal molybdenum phosphide (N—NiMo₃P), wherein
the transition metal is other than molybdenum, and
a plurality of pores and a plurality of other defects form active sites which are distributed laterally across the ultra-thin 2D porous sheet, that is, distributed between edges of the sheet.

In a third aspect, the invention provides an electrocatalyst comprising at least one ultra-thin 2D defect rich porous sheet of a crystalline inorganic material which is a nitrogen doped-nickel molybdenum phosphide (N—NiMo₃P), wherein
the defects and pores are located throughout an entirety of the ultra-thin 2D porous sheet, and
a plurality of pores and a plurality of other defects form active sites which are distributed laterally across the ultra-thin 2D porous sheet, that is, distributed between edges of the sheet.

N—NiMo₃P gives an outstanding performance in HER and full water splitting, and it is thought to be based on its engineered composition, where the M-P bond has been altered and elongated by N doping which creates +δ and −δ charges as active hot spots to absorb the intermediates and improve the reaction kinetics by optimizing the surface energies for effective catalysis.

Preferably, the inorganic material comprises a lattice spacing of about 0.239 nm, for example, as determined by XRD. About here means ±1%.

Preferably, nickel is present in amount of about 18% w/w of the inorganic material. About here means ±1%. The high concentration of Ni assures that it is not simply a dopant but a part of the structure that tunes the electron density of Mo in the d-band and modifies the energy states, creating favourable sites for water adsorption and hydrogen/oxygen desorption. The same is true of other non-Mo transition metals that are used in the materials of the invention.

Preferably, the inorganic material comprises nickel at a concentration in the range of about 12.2 ppb, and comprises molybdenum at a concentration in the range of about 53 ppb to about 73 ppb. About here means ±1%.

Preferably, the ultra-thin 2D defect rich porous sheet has a nanometer sized dimension in one direction and a micrometre sized dimension in at least one other direction. In this context, the nanometer sized dimension may be of from 1 nm to 100 nm, or of from 1 nm to 50 nm, or of from 1 nm to 10 nm, and the micrometer sized dimension may be of from 1 μm to 100 μm, or of from 1 μm to 50 μm, or of from 1 μm to 5 μm. The ultra-thin two-dimensional (2D) porous sheet advantageously provides a large exposed surface area and a unique range of electronic properties not available before for such 2D sheets where active sites are limited to edge exposed active sites. In contrast the materials of the invention have engineered to make the basal place of the sheets active in addition to the edge exposed active sites. This has been achieved by creating strain (bringing differentiated energy states) and dangling bonds as active sites by introducing defects (hetero-atoms or bond polarity) and pores. These engineered manipulations of the basal plane not only tune the active sites but also improve mass transport and conductivity. For the first time, the inventors have realised ultra-thin 2D defect rich porous sheets of a crystalline inorganic material which is a nitrogen doped-transition metal molybdenum phosphide (N—NiMo₃P; N—FeMoP), wherein the transition metal is other than molybdenum, and the defects including pores are located throughout an entirety of the ultra-thin 2D porous sheet, and not just the edges. Surprisingly, the stability of the materials means the active sites remain active for longer operation, even in containments rich in corrosive seawater. Providing a material with these properties overcomes a huge challenge in the art of electrolysis, and seawater electrolysis in particular.

Preferably, the nanometer sized dimension is about 10 nanometers or less, preferably about 2.5 nm to 10 nm, most preferably about 3.2 nm, and the micrometer sized dimension is about 10 microns or less, preferably about 5 microns or less, for example, in a lateral direction, for example as determined by Atomic Force Microscopy (AFM) or Transmission Electron Microscopy (TEM).

Preferably, the electrocatalyst according to the invention consists essentially of the crystalline inorganic material inorganic material.

Preferably, the inorganic material comprises molybdenum in an oxidation state of Mo⁶⁺ and/or Mo⁴⁺, for example, as determined by X-ray Photoelectron Spectroscopy (XPS). These oxidation states, in particular the higher oxidation states of the atoms within a catalyst of the invention which result after heteroatom and non-Mo transition metal as compared to the oxidation state in MoO₃ and Mo₃P are believed to be important for determining the activity and stability of the materials of the invention. Furthermore, the d orbitals of Mo atoms involved in these higher oxidation states tend to support the fast transfer of electrons with a low energy barrier. Due to the rapid transfer of electrons, Mo⁴⁺ oxidizes to Mo⁶⁺, which favours the formation of more active phases during the reaction (like the oxyhydroxide phase during OER) and leads to a stronger interaction with the adsorption intermediates.

Preferably, the pores are homogenously distributed right across the faces of the sheet structure of the inorganic material. Thus, active sites are not just confined to edges of each sheet as is typically the case.

Preferably, the inorganic material comprises transition metal-heteroatom bonds and molybdenum heteroatom bonds and, preferably transition metal-nitrogen bonds and molybdenum-nitrogen bonds.

Preferably, the inorganic material comprises transition metal-phosphorus bonds and molybdenum-phosphorus bonds.

Preferably, the case of N—NiMo₃P, the material has a crystal structure based on that of N—NiMoO₃ which is defined as orthorhombic MoO₃ (JCPDS No. 35-0609) where Mo is the main crystal-defining component. The Ni is incorporated into the MoO₃ lattice without changing the basic structure, however, alters the electronic distribution of MoO₃ as verified by the NEXAFS results of the Mo L-edge. After the phosphorization process, oxygen in the structure is replaced by phosphorus, and this conversion reaction changes the crystal structure geometry to tetragonal Mo₃P (JCPDS No. 89-2587), demonstrating that Mo is the structure-defining element while Ni is the structure modifier.

Preferably, the transition metal and the molybdenum each have a four-coordinate geometry. It is believed that molybdenum is the main crystal defining element, and in N—NiMo₃P described herein matches with diffraction pattern of α-MoO₃, with a small shift observed due to the introduction of N and Ni. The Ni atoms replace Mo in certain sits in the lattice. The N replaces all O sites in the MoO₃ starting material such that the material is oxide free.

Preferably, the transition metal, such as nickel or iron, and molybdenum form a core part of inorganic material's structure.

Preferably, the transition metal and the molybdenum atoms are bridged by phosphorus and/or heteroatoms.

Preferably, the inorganic material comprises oxidised-N species and NH₄⁺ ions on surfaces of the inorganic material.

Preferably, the inorganic material comprises adsorbed atmospheric oxygen.

Preferably, the N, Ni/Fe, Mo and P is homogenously distributed throughout the porous sheets of the inorganic material, for example, as determined by energy dispersive spectroscopy (EDS). Homogeneously distribution of the elements across the entire sheets helps in modulating the material's properties to achieve the maximum activity.

Preferably, the inorganic material is oxide free as determined by XRD analysis and/or Raman spectroscopic analysis.

In a fourth aspect, the invention provides for an electrocatalyst comprising at least one porous 2D sheet of at least one ultra-thin 2D defect rich porous sheet of a crystalline inorganic material which is a thermally phosphorized heteroatom doped-transition metal molybdenum oxide, wherein
the transition metal is other than molybdenum, and
a plurality of pores and a plurality of other defects forming active sites are distributed across each face of the ultra-thin 2D porous sheet.

Preferably the inorganic material is annealed prior to thermal phosphorization.

In a fifth aspect, the invention provides a use of an electrocatalyst according to one of the first to fourth aspects in an electrocatalytic reaction, for example, hydrogen generation, ammonia production or use in a fuel cell. Advantageously the electrocatalyst of the invention has a superior performance over commercial Pt/C, which require an overpotential of 22.5 and 73.5 mV to achieve 10 mA cm⁻² in 1.0 M KOH and seawater, respectively. It is believed that materials of the invention exhibit improved conductivities through heteroatom dopant, non-Mo transition metal in the core of the material which ensure sufficient electronic movement in the catalyst structure, faster ionic movements due to the pore-rich structure of sheets, faster reaction kinetics due to optimised surface energies, higher surface areas, active sites through the entirety of the 2D sheet, and faster mass transport contributing to the enhanced electrochemical performance due to the features described herein.

Further the materials are expected to be stable electrochemically, for example, in the case of N—NiMo₃P, exhibiting retention of at least 90% and preferably 98% of its activity during H₂ production in 1.0 M KOH, and exhibiting retention of at least 80% and preferably 82% of its activity during H₂ production in seawater for 24 hours.

In a sixth aspect, the invention provides a use of an electrocatalyst according to one of the first to fourth aspects in an electrocatalytic hydrogen evolution reaction (HER).

In a seventh aspect, the invention provides a use of an electrocatalyst according to one of the first to fourth aspects in an electrocatalytic oxygen evolution reaction (OER).

The material N—FeMoP described herein achieved a current density of 100 mA cm⁻² at a potential of 1.46 and 1.55 V for OER in 1.0 M KOH and seawater, respectively; and achieved a current density of 10 mA cm⁻² at an overpotential of 234 mV for HER in 1.0 M seawater. In contrast, N—NiMo₃P required a potential of 1.43 V and 1.58 V to achieve a current density of 10 mA cm⁻² for OER, in 1.0 M KOH and seawater, respectively. The material N—NiMo₃P described herein supports an exceptional OER activity, where it achieved a current density of 10 mA cm⁻² at overpotentials of only 196 and 346 mV, better than the commercial IrO₂, which required 313 and 385 mV to achieve 10 mA cm⁻², in 1.0 M KOH and seawater, respectively. The overpotential required by N—NiMo₃P and N—FeMoP in seawater is significantly smaller than the 490 mV overpotential required to initiate the CER and generate hypochlorite and thus avoids the formation of hypochlorite, where surface modification by polyanions will further assist in avoiding CER.

In an eighth aspect, the invention provides a use of an electrocatalyst according to one of the first to fourth aspects, in electrocatalytic electrolysis of seawater.

Desirably during such use (or processes described below) involving seawater as electrolyte, chloride evolution reaction (CER) is avoided such that the production of chlorine gas is avoided, for example, as determined by passing a gas to be tested through acetone at room temperature, whereby no chloroacetone or HCl is generated as indicated by qualitative testing with pH paper and/or GC-MS analysis.

In a ninth aspect, the invention provides a use of an electrocatalyst according to one of the first to fourth aspects, in electrocatalytic electrolysis of alkaline water.

Thus, advantageously, the catalysts of the invention service as a bifunctional catalysts for full water splitting, as preferred catalysts are capable of carrying out both anodic and cathodic reactions in the same electrolyte.

In a tenth aspect, the invention provides an electrochemical cell comprising one or more of:
an anode comprising an electrocatalyst according to one of the first to fourth aspects, and
a cathode comprising an electrocatalyst according to one of the first to fourth aspects, preferably, wherein the cell is configured as an electrolytic cell.

In some embodiments, an electrode, that is, anode and/or cathode for a cell can comprise a mixture of particles of the ultra-thin 2D defect rich porous sheet electrocatalyst of the invention, binder and optionally one or more electronically conductive additives and can be provided on a current collector, such as carbon paper or nickel foam.

In one embodiment, the anode (for OER) of the electrochemical cell comprises a porous 2D sheet of at least one ultra-thin 2D defect rich porous sheet of a crystalline inorganic material which is a heteroatom doped-iron molybdenum phosphide, such as a nitrogen-doped iron molybdenum phosphide, as described herein. In one embodiment, the cathode (for HER) of the electrochemical cell comprises a porous 2D sheet of at least one ultra-thin 2D defect rich porous sheet of a crystalline inorganic material which is a heteroatom doped-nickel molybdenum phosphide, such as a nitrogen-doped nickel molybdenum phosphide, as described herein. In such embodiments, the opposing anode/cathode completing the cell may be any suitable anode or cathode, and may not necessarily comprise an electrocatalyst as described herein. The electrolyte may be alkaline or sea water.

In one embodiment, the anode of the electrochemical cell comprises a porous 2D sheet of at least one ultra-thin 2D defect rich porous sheet of a crystalline inorganic material which is a heteroatom doped-iron molybdenum oxide, such as a nitrogen-doped iron molybdenum oxide and the cathode of the electrochemical cell comprises a porous 2D sheet of at least one ultra-thin 2D defect rich porous sheet of a crystalline inorganic material which is a heteroatom doped-nickel molybdenum phosphide, such as a nitrogen-doped nickel molybdenum phosphide, as described herein. The electrolyte may be alkaline or sea water.

In one embodiment, the anode of the electrochemical cell comprises a porous 2D sheet of at least one ultra-thin 2D defect rich porous sheet of a crystalline inorganic material which is a heteroatom doped-iron molybdenum oxide, such as a nitrogen-doped iron molybdenum oxide, or which is a heteroatom doped-iron molybdenum phosphide, such as a nitrogen-doped iron molybdenum phosphide, as described herein, and the cathode of the electrochemical cell comprises a porous 2D sheet of at least one ultra-thin 2D defect rich porous sheet of a crystalline inorganic material which is a heteroatom doped-nickel molybdenum phosphide, such as a nitrogen-doped nickel molybdenum phosphide, as described herein. The electrolyte may be alkaline or sea water.

In a preferred embodiment, the anode of the electrochemical cell comprises a porous 2D sheet of at least one ultra-thin 2D defect rich porous sheet of a crystalline inorganic material which is a heteroatom doped-iron molybdenum phosphide, such as a nitrogen-doped iron molybdenum phosphide, as described herein, and the cathode of the electrochemical cell comprises a porous 2D sheet of at least one ultra-thin 2D defect rich porous sheet of a crystalline inorganic material which is a heteroatom doped-nickel molybdenum phosphide, such as a nitrogen-doped nickel molybdenum phosphide, as described herein. In one embodiment, this electrochemical cell comprises an electrolyte that is an alkaline or sea water electrolyte.

In an eleventh aspect, the invention provides a process for electrocatalytic hydrogen (H₂) gas generation from an alkaline water electrolyte, comprising the step of:
carrying out a hydrogen evolution reaction (HER) in a cell comprising the electrolyte and an electrode comprising the electrocatalyst according to one of the first to fourth aspects, preferably whereby the process produces a current density of 10 mA cm⁻² at an overpotential of about 30 mV or less, more preferably about 25 mV or less, preferably in a 1.0 M KOH electrolyte, for example, as determined by linear sweep voltammetry (LSV).

A preferred overpotential of 23 mV may be achieved in a test electrolyte of 1.0 M KOH, for example, using N—NiMo₃P. In industrial applications, the alkaline water may be a solution of from about 1.0 M to about 6.0 M [OH⁻], e.g. KOH.

In a twelfth aspect, the invention provides a process for electrocatalytic oxygen (O₂) gas generation from an alkaline water electrolyte, comprising the step of:
carrying out an oxygen evolution reaction (OER) in a cell comprising the electrolyte and an electrode comprising the electrocatalyst according to one of the first to fourth aspects, preferably whereby the process produces a current density of 10 mA cm⁻² at an overpotential of about 250 mV or less, or 200 mV or less, more preferably at 198 mV or less, preferably in a 1.0 M KOH electrolyte, for example, as determined by linear sweep voltammetry (LSV).

A preferred overpotential of 196 mV may be achieved in a test electrolyte of 1.0 M KOH, for example, using N—NiMo₃P. In industrial applications, the alkaline water may be a solution of from 1.0 M to about 6.0 M [OH⁻], e.g., KOH.

In a thirteenth aspect, the invention provides a process for electrocatalytic electrolysis of alkaline water, preferably producing a current density of 10 mA cm⁻² at a potential of about 1.55 V or less, preferably about 1.52 V or less, preferably in a 1.0 M KOH electrolyte, for example, as determined by linear sweep voltammetry (LSV), the process comprising the steps of:
carrying out a hydrogen evolution reaction (HER) in a cell comprising the electrolyte and an electrode comprising the electrocatalyst according to one of the first to fourth aspects, and in the same cell,
carrying out an oxygen evolution reaction (OER) at an anode comprising the electrocatalyst according to one of the first to fourth aspects.

A preferred potential of 1.52 mV may be achieved in a test electrolyte of 1.0 M KOH, for example, using N—NiMo₃P. In industrial applications, the alkaline water may be a solution of from 1M to 6M [OH⁻], e.g. KOH.

In a fourteenth aspect, the invention provides a process for electrocatalytic hydrogen (H₂) gas generation from a seawater electrolyte, comprising the step of:
carrying out a hydrogen evolution reaction (HER) in a cell comprising the electrolyte and an electrode comprising the electrocatalyst according to one of the first to fourth aspects, preferably whereby the process produces a current density of 10 mA cm⁻² at an overpotential of about 40 mV or less, more preferably about 35 mV or less for example, as determined by linear sweep voltammetry (LSV).

A preferred overpotential of 35 mV may be achieved in seawater, for example, using N—NiMo₃P.

In a fifteenth aspect, the invention provides a process for electrocatalytic oxygen (O₂) gas generation from a seawater electrolyte comprising the step of:
carrying out an oxygen evolution reaction (OER) in a cell comprising the electrolyte and an electrode comprising the electrocatalyst according to one of the first to fourth aspects, preferably whereby the process produces a current density of 10 mA cm⁻² at an overpotential of about 360 mV or less, more preferably at 350 mV or less, for example, as determined by linear sweep voltammetry (LSV).

A preferred overpotential of 346 mV may be achieved in seawater, for example, using N—NiMo₃P. A preferred overpotential of 320 mV may be achieved in seawater, for example, using N—FeMoP. No chlorine gas is produced as CER is avoided.

In a sixteenth aspect, the invention provides a process for electrocatalytic electrolysis of seawater water, preferably producing a current density of 10 mA cm⁻² at an overpotential of about 1.60 V or less, for example, as determined by linear sweep voltammetry (LSV), the process comprising the steps of:
carrying out a hydrogen evolution reaction (HER) in a cell comprising the electrolyte and an electrode comprising the electrocatalyst according to one of the first to fourth aspects, and in the same cell,
carrying out an oxygen evolution reaction (OER) at an anode comprising the electrocatalyst according to one of the first to fourth aspects.

A preferred overpotential of 320 mV may be achieved in seawater, for example, using N—NiMo₃P. No chlorine gas is produced as CER is avoided.

In a seventeenth aspect, the invention provides a use of a transition metal foam free of molybdenum as template and source of transition metal atoms in the synthesis of ultra-thin 2D defect rich porous sheet of:
a thermally phosphorized heteroatom doped-transition metal molybdenum oxide; or
a heteroatom doped-transition metal molybdenum phosphide.

Preferably, the transition metal foam free of molybdenum is a nickel foam, an iron foam or a cobalt foam, preferably a nickel foam.

In an eighteenth aspect, the invention provides a use of an organic source of heteroatoms atoms in the synthesis of ultra-thin 2D defect rich porous sheet of:
a thermally phosphorized heteroatom doped-transition metal molybdenum oxide; or
a heteroatom doped-transition metal molybdenum phosphide.

Preferably, the organic source is hexamethylenetetramine as a source of nitrogen atoms.

In a nineteenth aspect, the invention provides a use of hexamethylenetetramine as a source of nitrogen atoms in the synthesis of ultra-thin 2D defect rich porous sheet of:
a thermally phosphorized heteroatom doped-transition metal molybdenum oxide; or
a heteroatom doped-transition metal molybdenum phosphide.

Preferably, the organic source of heteroatoms is used in combination with the metal foam in the synthesis.

In a twentieth aspect, the invention provides a use of an organic source of heteroatoms atoms in the synthesis of ultra-thin 2D defect rich porous sheet of:
a thermally phosphorized heteroatom doped-transition metal molybdenum oxide; or
a heteroatom doped-transition metal molybdenum phosphide,
wherein the synthesis involves reacting a transition metal foam which is free of molybdenum, preferably nickel foam, and an organic source of heteroatom, preferably hexamethylenetetramine, in the presence of molybdenum trioxide a hydrothermal process, followed by annealing, and a subsequent thermal phosphorization step to generate a phosphide product in the form of ultra-thin 2D defect rich porous sheets.

In a twenty first aspect, the invention provides a use of a transition metal foam which free of molybdenum as a pore template and source of transition metal atoms in conjunction with an organic source of heteroatom dopant in the synthesis of ultra-thin 2D defect rich porous sheet of:
a thermally phosphorized heteroatom doped-transition metal molybdenum oxide; or
a heteroatom doped-transition metal molybdenum phosphide.

Desirably, the transition metal foam free of molybdenum is a nickel foam, an iron foam or a cobalt foam, preferably a nickel foam, and wherein the organic source is hexamethylenetetramine as a source of nitrogen atoms.

Desirably, the synthesis involves reacting a transition metal foam which is free of molybdenum, preferably nickel foam, and an organic source of heteroatom, preferably hexamethylenetetramine, in the presence of a peroxomolybdic solution in a hydrothermal process, followed by annealing, and a subsequent thermal phosphorization step to generate a phosphide product in the form of ultra-thin 2D defect rich porous sheets.

In a twenty second aspect, the invention provides a method of synthesizing ultra-thin 2D defect rich porous sheets of a heteroatom doped-transition metal molybdenum phosphide, comprising the steps of:
combining a peroxomolybdic solution, a non-molybdenum transition metal foam, and with an organic source of heteroatoms to form a first reactant solution;
hydrothermally reacting the first reactant solution and recovering a dry solid powder product on completion of the hydrothermal reaction;
annealing the dry solid powder under an inert atmosphere to form an annealed powder material;
phosphorizing the annealed powder material with a source of phosphorus under an inert atmosphere to from the ultra-thin 2D defect rich porous sheets of a heteroatom doped-transition metal molybdenum phosphide.

Desirably, the non-molybdenum transition metal foam is nickel foam.

Desirably, wherein the organic source of heteroatoms is hexamethylenetetramine (HMTA), preferably a solution of hexamethylenetetramine (HMTA).

Desirably, the hydrothermal reaction is carried out in an autoclave at a temperature of about 200° C., for example, for about 24 hours.

Desirably, the annealing step is carried out, preferably in a tube furnace, at a temperature of about 300° C. to about 400° C., preferably about 350° C. for example, for about 2 hours, preferably at a heating rate of about 3° C./minute.

Desirably, the phosphorizing step is carried out, preferably in a tube furnace, at a temperature of about 350° C. to about 450° C., preferably about 400° C. for example, for about 3 hours, preferably at a heating rate of about 3° C./minute.

Desirably, the source of phosphorus is an alkali hypophosphite, such as sodium hypophosphite.

Desirably, the inert atmosphere is a nitrogen (N₂) atmosphere.

Desirably, the ratio of the annealed powder material and the P source is kept at about 1:30.

In the case of HMTA and nickel foam, it is believed that HMTA and nickel foam as a template facilitate development of the defect-rich porous sheets of the invention, as HMTA releases NH₄⁺ ions, which bind with Mo atoms and cause exfoliation and formation of ultrathin sheets, which upon annealing, results in nitrogen doping. Other combinations of organic heteroatom (e.g., B, P, etc organic source) are expected to interact similarly with non-Mo transition metal foams in a similar matter to result in heteroatom doping and non-Mo transition metal insertion into some of the Mo sites in the MoO₃ starting material. The annealing step connect the loosely attached sheets and introduce the desirable larger grain boundaries. Furthermore, in the case of HTMA and nickel foam, as the crystallite's edges were rich with NH₄⁺ ions, which on annealing, leave nitrogen doping at grain boundaries, making them special active sites with distinct energy to work in harsh seawater.

Furthermore, it is thought that annealing during synthesis removes any unreacted compounds and helps in increasing the volume of the catalyst, and after phosphorization the pore size decreases due to the edge reaction with phosphorus. Such mass redistribution relating to the pores means their internal structure increases the surface area and makes these pores more active and easily accessible by molecules/ions and for solvation. This contributes positively toward the material activity.

Preferred aspects and features described in relation to one aspect, apply equally to all other aspects described.

All of the electrocatalytic processes and uses described herein may be carried out at any temperature, but in the present experiments described, are carried out at room temperature, for example, that is, from 20, 21, 22, 23, 24 or 25° C., preferably, 25° C.

While a metal foam is used as a template for the 2D ultra-thin porous sheets of the invention, the foam is preferably self-sacrificial. Preferably, the resultant electrocatalyst of the invention is free of residual metal from the foam, for example, most preferably up to and including 98%, 98.5%, 99%, 99.5%, and most preferably 100% free of metal from the foam, for example, Ni in case of Ni foam.

The porous sheets are micrometer sized in at least one lateral direction.

The catalysts also show excellent stability for several hundred hours and can work under industrial conditions. A key advantage of the catalysts is their preference for OER over chlorine evolution reaction in actual seawater at industrial conditions which is important to inhibit CER to avoid the production of chlorine, reduce energy consumption and make them stable in actual seawater systems. These catalysts do not require corrosive acidic electrolytes. The exceptionally performing developed catalyst materials of the invention can be utilised in the renewable energy and automotive industries to replace the current noble metal-based catalysts to generate hydrogen at a low cost using the earth's abundant water resources. Besides, these materials can also be utilized in various other sectors like ammonia production, fuel cell and many other catalytic reactions with some optimizations.

As used herein, the term “about”, unless stated to the contrary, typically refers to a range of up to +/−10% of the designated value, and includes smaller ranges therein, for example +/−5%, or +/−1% of the designated value.

Where the terms “comprise”, “comprises” and “comprising” are used in the specification (including the claims) they are to be interpreted as specifying the stated features, integers, steps or components, but not precluding the presence of one or more other features, integers, steps or components, or group thereof. “Consisting essentially of” means that additional component(s), composition(s) or method step(s) do not materially change the basic and novel characteristics of the compositions and methods described herein may be included in those compositions or methods.

It is to be appreciated that certain features that are, for clarity, described herein in the context of separate embodiments, may also be provided in combination in a single embodiment. Conversely, various features that are, for brevity, described in the context of a single embodiment, may also be provided separately or in any subcombination.

Further aspects of the invention appear below in the detailed description of the invention.

### BRIEF DESCRIPTION OF DRAWINGS

Embodiments of the invention will herein be illustrated by way of example only with reference to the accompanying drawings in which:

FIG. 1 shows N—NiMoO₃ (a) TEM image at low magnification (the inset shows SAED pattern), (b) TEM image at high magnification indicating pores, and (c) HRTEM showing defects and lattice spacing in the inset. N—NiMo₃P (d) TEM image at low magnification (the inset shows SAED pattern), (e) TEM image at high magnification indicating pores, and (f) HRTEM showing defects and lattice spacing in the insets;

FIG. 2 shows N—NiMoO₃ before annealing (a) TEM, (b) HRTEM. N—NiMoO₃ after annealing (c) TEM, (d) HRTEM (yellow lines show the grain boundaries during sheet formation). These indicate the role of the annealing process during which energy is provided to the small ultrathin sheets that join to form larger sheets, giving rise to additional grain boundaries that act as additional active sites for improved electrochemical performance;

FIG. 3 shows a SEM image of (a) MoO₃, (b) N—MoO₃, (c) N—NiMoO₃ (without Ni foam), d) N—NiMoO₃ (with Ni foam), (e) N—NiMo₃P and (f) N—NiMo₃P after testing in seawater electrolyte. MoO₃ has a flake like morphology which was retained even after doping with Nitrogen. However, rod like morphology was observed when nickel powder was added. Sheet like morphology was obtained when nickel foam was added giving micrometer scale sheets;

FIG. 4 shows a TEM image of N—NiMoO₃ synthesized using Ni powder to evaluate the effect of Ni foam (a) at low magnification, (b) at high magnification;

FIG. 5 shows AFM results of cross-section topography indicating pores (a) N—NiMoO₃, (b) N—NiMo₃P. The inset shows their corresponding thickness. Scan lines are shown in white. (c) XRD pattern of N-NiMo₃P; (d) Raman spectra of N—NiMoO₃ and N—NiMo₃P, (e) FIR-FTIR, and (f) Pore volume distribution curves;

FIG. 6 shows XRD spectrum of N—NiMoO₃ matching well with α-MoO₃ (JCPDS No. 35-0609), indicating that molybdenum is the crystal defining element;

FIG. 7 shows (a) Raman Spectra and (b) O K-edge NEXAFS spectra of MoO₃, N—MoO₃, and N—NiMoO₃ indicating dangling bonds;

FIG. 8. FTIR of N—NiMoO₃ and N—NiMo₃P showing nitrate and hydroxyl in the oxide and phosphate, nitrate, and hydroxyl groups in phosphide, indicating the presence of the polyanion groups in both oxide and phosphide;

FIG. 9 shows (a) Nitrogen adsorption/desorption isotherms for N—NiMoO₃ and N—NiMo₃P providing information regarding the distribution of pores. The results show that the oxide isotherm resembles Type Ill while the phosphide isotherm resembles Type IV (based on the IUPAC classification of adsorption isotherms),¹ (b) Pore size distribution curves;

FIG. 10 shows deconvoluted XPS spectra of (a) Mo 3d, (b) Ni 2p, (c) N 1s, (d) P 2p for N—NiMoO₃ and N—NiMo₃P. STEM images and EDS elemental maps of (e) N—NiMoO₃ and (f) N—NiMo₃P. NEXAFS spectra of (g) O K-edge of oxides, (h) Mo L-edge of oxides, and (i) Mo L-edge of phosphides;

FIG. 11 shows (a) O 1s XPS spectra of N—NiMoO₃ and N—NiMo₃P. The deconvoluted O 1s spectrum of N—NiMoO₃ shows peaks at 530.5 and 531.4 eV, corresponding to metal-oxygen bond and adsorbed oxygen in the OH group, while the deconvoluted O 1s spectrum of N—NiMo₃P shows peaks at 531.14 and 532.3 eV arising from phosphorus-oxygen bond and atmospheric adsorbed oxygen, respectively and (b) N K-edge of oxides and phosphides;

FIG. 12 shows (a) HER and (b) OER results for NiMo₃P and N—NiMo₃P in 1.0 M KOH and seawater electrolyte;

FIG. 13 shows N—NiMoO₃, N—NiMo₃P, and Pt/C in 1.0 M KOH and seawater (a) Linear sweep voltammetry curves (HER), (b) corresponding Tafel plots. (c) Plots showing double-layer capacitance (C_{dl}) of N—NiMoO₃ and N—NiMo₃P, (d) Current-time (I-t) curves of N—NiMo₃P and Pt/C for 24 h in 1.0 M KOH and seawater. N—NiMoO₃, N—NiMo₃P, and IrO₂ in 1.0 M KOH and seawater (e) Linear sweep voltammetry curves (OER), (f) corresponding Tafel plots. Note: All the polarization curves are iR corrected;

FIG. 14 shows HER results for N—NiMo₃P in 1.0 M KOH and seawater electrolyte (a) on Ni foam without IR compensation, (b) on C paper electrode;

FIG. 15 shows cyclic voltammetric (CV) curves in the voltage range of 0.966-1.066 V vs. RHE, with scan rates ranging from 10 to 50 mV s⁻¹ (a) N—NiMoO₃, (b) N—NiMo₃P indicating that phosphide has a higher electrochemical active surface area than oxide;

FIG. 16 shows Nyquist plots for N—NiMoO₃ and N—NiMo₃P in KOH and SW. Nyquist plots indicate that N—NiMo₃P faces the smallest electrolyte resistance when KOH is used as an electrolyte as compared to the seawater electrolyte, followed by N—NiMoO₃ in KOH and seawater electrolyte.

FIG. 17 shows current-time (I-t) curves of N—NiMo₃P for 100 h in 1.0 M KOH;

FIG. 18 shows current-time (I-t) curves for Pt/C in 1.0 M KOH for 24 h indicating poor stability of Pt/C as it loses more than half of its initial current density;

FIG. 19 shows polarization curves before and after 1000 cycles of CV test (a) N—NiMo₃P KOH, (b) N—NiMo₃P SW. It can be observed that after CV testing of 1000 cycles in 1.0 m KOH electrolyte, the polarization curves for N—NiMo₃P almost overlap with each other, while in seawater electrolyte, only a minor difference was observed indicating the excellent stability of the catalyst;

FIG. 20 shows (a) pH paper test of (A) HCl in water, (B) water, (C) water+acetone, (D) acetone, and (E) acetone+gas. The pH paper test shows that the (A) has acidic pH while (B) has neutral pH which should be true for water and (C-E) have near neutral pH. This demonstrate that the pH of acetone and acetone+gas are the same indicating that no chlorine was generated at anode. (b) GCMS of the acetone+gas solvent;

FIG. 21 shows N-NiMo₃P∥N-NiMo₃P and Pt/C∥IrO₂ in 1.0 M KOH and sweater (a) Polarization curves, (b) corresponding Tafel plots, (c) Current-time (I-t) curves for 24 h. Ex-situ characterization of N—NiMo₃P after electrochemical testing in seawater (d) TEM image (HRTEM in the inset), (e) Raman Spectra, (f) STEM image, (g) EDS elemental maps, (h) Deconvoluted XPS spectra of Mo 3d, Ni 2p, N 1s, and P 2;

FIG. 22 shows current-time (I-t) curves for Pt/C∥IrO₂ in 1.0 M KOH for 24 h indicating poor stability of the full cell as it retains less than 5% of its initial current density;

FIG. 23 shows the XRD of N—NiMo₃P after electrochemical testing in seawater electrolyte;

FIG. 24 shows the TEM elemental map of ‘O’ after electrochemical seawater electrolysis of N—NiMo₃P indicating the presence of a thin oxide layer on the surface, possibly because of the presence of phosphorus-oxygen or nitrogen-oxygen species or slight surface oxidation after electrochemical testing;

FIG. 25 shows O 1s XPS spectra of N—NiMo₃P after seawater splitting having a peak at 531.14 eV, corresponding to the phosphorus-oxygen bond;

FIG. 26 shows a schematic of the synthesis of porous N—NiMo₃P and the electrochemical seawater splitting process. The porous sheets of N—NiMo₃P, owing to its large surface area with abundant active sites and pores, lead to better mass transport providing exceptional electrochemical performance in a seawater electrolyte. Note: the ball stick model is presenting the fundamental structure of oxide and phosphide not the surface chemistry of sheet;

FIG. 27 shows the long term stability of N—NiMo₃P as both cathode and anode in seawater;

FIG. 28 shows FeMo oxide, FeMoP and IrO₂ (a) OER LSV curves, (b) Tafel plots, (c) Double layer capacitance (C_{dl}) and (d) Electrochemical impedance spectroscopy in 1 M KOH and sea water; and

FIG. 29 shows HER LSV plots for FeMo oxide and N—FeMo phosphide.

### DETAILED DESCRIPTION

Transition metal phosphides (TMPs) have a tuneable structure, composition, and high intrinsic catalytic activity. However, their poor stability and limited catalytic activity due to the rapid loss of active sites are key problems associated with their use on an industrial scale in particular. Developing a TMP catalyst with abundant accessible and stable active sites is a challenging problem to be solved.

The inventors have now addressed these problems through engineering of a new class of material by adjusting the structure and composition of TMP catalysts by dramatically increasing the number of active sites, and stabilizing the active sites through appropriate engineering across each active site.

In particular the TMP based electrocatalysts of the invention have a unique structure as a two-dimensional (2D) material in ultrathin porous sheet format. The (2D) material in ultrathin porous sheet format provides a large exposed surface area and the catalyst material has been provided with structural and compositional modifications that result in a unique range of stabilized electronic properties that favour their use as electrocatalysts, particularly in the HER, but also for OER, enabling their use as bifunctional catalysts in full water splitting electrolysis of alkaline water and seawater.

Traditionally, 2D materials only provide edge-exposed active sites, which have a role in improving the electrocatalyst activity, but their large inert basal planes limit their full capacity. The inventors have now found a way make the basal plane active in a way that enhances the unique 2D features. The inventors have achieved this for their modified mixed metal TMP based materials by creating strain (bringing differentiated energy states) and dangling bonds as active sites by introducing defects (heteroatoms or bond polarity) and pores. These engineered manipulations of the basal plane not only tune the active sites but also improve mass transport and conductivity.

The catalytic material of the invention is based on ultrathin (in the nanometer range), 2D porous sheets which comprise large area sheets of several microns, the basal planes of which have been engineered to have active sites across the sheets and further engineered to keep them active for longer operation, especially in containments rich in corrosive seawater.

The present invention relates to a TMP based electrocatalyst for electrochemical redox reactions involved in electrolysis (e.g., HER, OER, and full splitting of water) which is composed of porous sheets of, in one embodiment, nitrogen-doped NiMo₃P (N—NiMo₃P) having a sheet size of several microns. The presence of large homogenous pores in the basal plane of these sheets makes them catalytically more active and ensures faster mass transfer. The introduction of N and Ni into MoP significantly tunes the electronic density of Mo, surface chemistry, and metal-non-metal bond lengths, optimizing surface energies, creating new active sites, and increasing electrical conductivity. The presence of metal-nitrogen bonds and surface polyanions increases the stability and improves anti-corrosive properties against chlorine chemistry. Ultimately, the N—NiMo₃P sheets show remarkable performance as they only require overpotentials of 23 and 35 mV for hydrogen evolution reaction, and catalyze full water splitting at 1.52 and 1.55 V to achieve 10 mA cm⁻² in 1.0 M KOH and seawater, respectively. Hence, structural and compositional control can make catalysts effective in realizing low-cost hydrogen directly from seawater. Other nitrogen-doped transition metal molybdenum oxide electrocatalysts have also been produced based on iron as the transition metal.

Further the invention relates to design and preparation of, in one embodiment, porous nitrogen-doped NiMo₃P (N—NiMo₃P) sheets of several micron sizes using a facile process. This unique catalyst has numerous active sites for efficient water catalysis as the presence of Ni and N assists in the redistribution of Mo's electron densities, enhancing the electrical conductivity and tuning the metal-non-metal bond lengths. The large homogenous pores lead to better mass transport and new active sites at the dangling bond sites of the pore edges, making the basal plane of the sheets active. The metal-nitrogen bond is responsible for the anti-corrosive properties to overcome the harsh seawater environment. The higher electronegativity of nitrogen (metal-nitrogen bonds) helps in improving the stability of active sites through the electron-withdrawing capability and helping the metal atoms to obtain a higher valence state, hence improving the transfer of electrons and mobilizing the electronic density of the catalyst. Moreover, the metal-nitrogen bond decreases the diffusion rate of any unwanted molecules/ions to the surface of the catalyst, decreasing the contact between the reactants and the seawater electrolyte. The presence of polyanions on the surface (phosphate, sulfate and nitrate) safeguards the catalyst from chlorine chemistry. The phosphate, nitrate, and hydroxyl ions (confirmed by the FTIR and XPS analysis) make a polyanion shield to form a protective coating on the surface. The presence of these polyanions on the surface of the catalyst is known to improve the cation selectivity and tend to repel and block the chloride anions. Thus, these polyanions play a crucial role in corrosion inhibition preventing chloride anions from reaching catalyst and corroding the underlying surface.

In summary, the inventors have developed a facile method to prepare and engineer porous sheets of, in one embodiment, N-NiMO₃P through thermally assisted wet chemistry. The resulting large area sheets containing transition metal, e.g., Ni, and N dopants assist in the redistribution of electronic densities of Mo, tuning metal-non-metal bond lengths, and enhancing electrical conductivity. This creates a unique catalyst that has significantly increased active sites for efficient water catalysis. The porous structure of the sheets not only allows faster mass transport but also introduces additional active sites at dangling bond sites at the pore edges, making the entire basal plane of large N—NiMo₃P sheets active. The presence of a metal-nitrogen bond provides anti-corrosive properties to the catalyst to tackle the harsh seawater environment, while the existence of surface polyanions (phosphate and nitrate) protects the catalyst against chlorine chemistry. Further, GC-MS analysis showed that as-synthesized catalyst showed high selectivity towards OER with complete suppression of CER. Hence, this work demonstrates a simple strategy to synthesize highly effective catalysts for direct seawater electrolysis, which is crucial in reducing the strain on freshwater resources and avoiding energy-intensive and carbon-emitting desalination processes.

### Embodiments

Embodiment 1. An electrocatalyst comprising at least one ultra-thin 2D defect rich porous sheet of a crystalline inorganic material which is a heteroatom doped-transition metal molybdenum phosphide, wherein
   the transition metal is other than molybdenum, and
   a plurality of pores and a plurality of other defects form active sites which are distributed laterally across the ultra-thin 2D porous sheet, that is, distributed between edges of the sheet.
Embodiment 2. An electrocatalyst according to Embodiment 1, wherein the inorganic material is polycrystalline, that is, comprises a plurality of crystallites having at least one grain boundary defect at interfaces between adjacent crystallites.
Embodiment 3. An electrocatalyst according to Embodiment 1 or Embodiment 2, wherein each sheet has a basal plane which comprises the plurality of pores and the plurality of defects, preferably wherein the defects are selected from one or more of grain boundaries, heteroatom doping, and bond polarity.
Embodiment 4. An electrocatalyst according to any one of the preceding Embodiments, wherein pores and other defects are homogenously distributed throughout the sheet.
Embodiment 5. An electrocatalyst according to any one of the preceding Embodiments, wherein pores in the sheet have pore edges which comprise electrochemically active dangling bond sites.
Embodiment 6. An electrocatalyst according to any one of the preceding Embodiments, wherein edges of the sheet comprise electrochemically active sites, such as dangling bond sites.
Embodiment 7. An electrocatalyst according to any one of the preceding Embodiments, wherein the heteroatom doping occurs at grain boundaries, and the transition metal is inserted into a Mo core of the inorganic material.
Embodiment 8. An electrocatalyst according to any one of the preceding Embodiments, wherein the heteroatom dopant is a heteroatom, particularly an electron withdrawing heteroatom, selected from one or more of: nitrogen, boron, sulfur and phosphorus, preferably boron and phosphorus, most preferably nitrogen.
Embodiment 9. An electrocatalyst according to any one of the preceding Embodiments, wherein the heteroatom is nitrogen and the electrocatalyst is nitrogen doped-transition metal-molybdenum phosphide.
Embodiment 10. An electrocatalyst comprising at least one ultra-thin 2D defect rich porous sheet of a crystalline inorganic material which is a nitrogen doped-transition metal molybdenum phosphide (N—NiMo₃P), wherein
   the transition metal is other than molybdenum, and
   a plurality of pores and a plurality of other defects form active sites which are distributed laterally across the ultra-thin 2D porous sheet, that is, distributed between edges of the sheet.
Embodiment 11. An electrocatalyst according to any one of the preceding Embodiments, wherein the transition metal is, for example, a first-row transition metal, preferably selected from nickel (Ni), cobalt (Co), and iron (Fe), most preferably nickel (Ni).
Embodiment 12. An electrocatalyst according to any one of the preceding Embodiments, wherein the inorganic material comprises the transition metal in the (II) oxidation state, preferably nickel in the Ni²⁺ oxidation state, for example, as determined by X-ray Photoelectron Spectroscopy.
Embodiment 13. An electrocatalyst according to any one of the preceding Embodiments, wherein the inorganic material comprises a shield of one or more polyanions which repel negative anions, for example, chloride, from surfaces of the inorganic material.
Embodiment 14. An electrocatalyst according to Embodiment 13, wherein the polyanions comprise one or more of: phosphate, nitrate and hydroxyl, for example as determined by X-ray photoelectric spectroscopy, FTIR and/or XPS analysis.
Embodiment 15. An electrocatalyst according to any one of the preceding Embodiments, wherein the pores comprises one or more of:
   micropores, preferably of average pore diameter of from about 0.75 nm to about 1.20 nm, more preferably about 1 nm to about 1.3 nm, for example, as determined by Barrett-Joyner-Halenda (BJH) analysis of nitrogen adsorption/desorption isotherms; and
   mesopores, preferably of average pore diameter of from about 2 nm to about 50 nm, more preferably about 5 nm to about 25 nm for example, as determined by Barrett-Joyner-Halenda Halenda (BJH) analysis of nitrogen adsorption/desorption isotherms.
Embodiment 16. An electrocatalyst according to any one of the preceding Embodiments, wherein the pores comprise a pore volume ranging from about 3.00×10⁻³ cm³ g⁻¹ to about 7.00×10⁻³ cm³ g⁻¹, more preferably from about 4.00×10⁻³ cm³ g⁻¹ to about 6.00×10⁻³ cm³ g⁻¹, and most preferably about 5.10×10⁻³ cm³ g⁻¹ in the case of a nitrogen doped-nickel molybdenum phosphide (N—NiMo₃P), for example, as determined by Barrett-Joyner-Halenda Halenda (BJH) analysis of nitrogen adsorption/desorption isotherms.
Embodiment 17. An electrocatalyst according to any one of the preceding Embodiments, wherein the inorganic material has a surface area of greater than about 5.00 m² g⁻¹, preferably greater than about 12.50 m² g⁻¹, more preferably greater than about 15.00 m² g⁻¹, and most preferably about 19.29 m² g⁻¹ in the case of a nitrogen doped-nickel molybdenum phosphide (N—NiMo₃P), for example, as determined by Brunauer-Emmett-Teller (BET) analysis of nitrogen adsorption/desorption isotherms.
Embodiment 18. An electrocatalyst comprising at least one ultra-thin 2D defect rich porous sheet of a crystalline inorganic material which is a nitrogen doped-nickel molybdenum phosphide (N—NiMo₃P), wherein a plurality of pores and a plurality of other defects form active sites which are distributed laterally across the ultra-thin 2D porous sheet, that is, distributed between edges of the sheet.
Embodiment 19. An electrocatalyst according to Embodiment 18, wherein the inorganic material comprises a lattice spacing of about 0.239 nm, for example, as determined by XRD.
Embodiment 20. An electrocatalyst according to Embodiment 18 or Embodiment 19, wherein nickel is present in amount of about 18% w/w of the inorganic material.
Embodiment 21. An electrocatalyst according to any one of Embodiments 18 to 20 wherein inorganic material comprises nickel at a concentration in the range of about 12.2 ppb, and comprises molybdenum at a concentration in the range of about 53 ppb to about 73 ppb.
Embodiment 22. An electrocatalyst according to any one of the preceding Embodiments, wherein the ultra-thin 2D defect rich porous sheet has a nanometer sized dimension in one direction and a micrometre sized dimension in a lateral direction.
Embodiment 23. An electrocatalyst according to Embodiment 22, wherein
   the nanometer sized dimension is about 10 nanometers or less, preferably about 2.5 nm to 10 nm, most preferably about 3.2 nm, for example, as determined by Atomic Force Microscopy (AFM) or Transmission Microscopy (TEM); and
   the micrometer sized dimension is about 10 microns or less, preferably about 5 microns or less, for example, in a lateral direction, for example, as determined by Atomic Force Microscopy (AFM) or Transmission Microscopy (TEM).
Embodiment 24. An electrocatalyst according to any one of the preceding Embodiments, consists essentially of the crystalline inorganic material inorganic material.
Embodiment 25. An electrocatalyst according to any one of the preceding Embodiments, wherein the inorganic material comprises molybdenum in a high oxidation state of Mo⁶⁺ and/or Mo⁴⁺, for example, as determined by X-ray Photoelectron Spectroscopy (XPS).
Embodiment 26. An electrocatalyst according to any one of the preceding Embodiments, wherein pores and other defect are homogenously distributed throughout the porous sheet structure of the inorganic material.
Embodiment 27. An electrocatalyst according to any one of the preceding Embodiments, wherein the inorganic material comprises transition metal-heteroatom bonds and molybdenum-heteroatom bonds and, preferably transition metal-nitrogen bonds and molybdenum-nitrogen bonds.
Embodiment 28. An electrocatalyst according to any one of the preceding Embodiments, wherein the inorganic material comprises transition metal-phosphorus bonds and molybdenum-phosphorus bonds.
Embodiment 29. An electrocatalyst according to any one of the preceding Embodiments, wherein the transition metal and the molybdenum each have a four-coordinate or tetrahedron geometry.
Embodiment 30. An electrocatalyst according to any one of the preceding Embodiments, wherein the nickel and molybdenum form a core part of the inorganic material structure.
Embodiment 31. An electrocatalyst according to any one of the preceding Embodiments, wherein the transition metal and the molybdenum atoms are bridged by phosphorus atoms and/or heteroatoms.
Embodiment 32. An electrocatalyst according to any one of the preceding Embodiments, wherein the inorganic material comprises oxidised-N species and NH₄⁺ ions on surfaces of the inorganic material.
Embodiment 33. An electrocatalyst according to any one of the preceding Embodiments, wherein the inorganic material comprises adsorbed atmospheric oxygen.
Embodiment 34. An electrocatalyst according to any one of the preceding Embodiments, wherein the heteraoatoms, transition metal, Mo and P, are homogenously distributed throughout the porous sheets of the inorganic material, for example, as determined by energy dispersive spectroscopy (EDS).
Embodiment 35. An electrocatalyst according to any one of the preceding Embodiments, wherein the inorganic material is oxide free as determined by XRD analysis and/or Raman spectroscopic analysis.
Embodiment 36. An electrocatalyst comprising at least one porous 2D sheet of at least one ultra-thin 2D defect rich porous sheet of a crystalline inorganic material which is a thermally phosphorized heteroatom doped-transition metal molybdenum oxide, wherein
   the transition metal is other than molybdenum, and
   a plurality of pores and a plurality of other defects form active sites which are distributed laterally across the ultra-thin 2D porous sheet, that is, distributed between edges of the sheet.
Embodiment 37. Use of an electrocatalyst according to any one of the preceding Embodiments, in an electrocatalytic reaction.
Embodiment 38. Use of an electrocatalyst according to any one of Embodiments 1 to 36, in an electrocatalytic hydrogen evolution reaction (HER).
Embodiment 39. Use of an electrocatalyst according to any one of Embodiments 1 to 36, in an electrocatalytic oxygen evolution reaction (OER).
Embodiment 40. Use of an electrocatalyst according to any one of Embodiments 1 to 36, in electrocatalytic electrolysis of seawater.
Embodiment 41. Use of an electrocatalyst according to any one of Embodiments 1 to 36, in electrocatalytic electrolysis of alkaline water, for example, preferably in a 1.0 M KOH electrolyte as a test method, or a 1-6 M KOH solution.
Embodiment 42. Use of any one of Embodiments 37 to 41, wherein the use involves seawater as electrolyte and chlorine evolution reaction (CER) and accompanying production of chlorine is avoided.
Embodiment 43. An electrochemical cell comprising one or more of:
   an anode comprising an electrocatalyst according to any one of Embodiments 1 to 36, and
   a cathode comprising an electrocatalyst according to any one of Embodiments 1 to 36, preferably, wherein the cell is configured as an electrolytic cell.
Embodiment 44. An electrochemical cell according to Embodiment 43, further comprising an electrolyte selected from alkaline water, preferably in a 1.0 M KOH electrolyte as a test method, or a 1-6 M KOH industrial concentration solution, and seawater.
Embodiment 45. A process for electrocatalytic hydrogen (H₂) gas generation from an alkaline water electrolyte, comprising the step of:
   carrying out a hydrogen evolution reaction (HER) in a cell comprising the electrolyte and an electrode comprising the electrocatalyst according to any one of Embodiments 1 to 36, preferably whereby the process produces a current density of 10 mA cm⁻² at an overpotential of about 30 mV or less, more preferably about 25 mV or less, preferably in a 1.0 M KOH electrolyte, for example, as determined by linear sweep voltammetry (LSV).
Embodiment 46. A process for electrocatalytic oxygen (O₂) gas generation from an alkaline water electrolyte comprising the step of:
   carrying out an oxygen evolution reaction (OER) in a cell comprising the electrolyte and an electrode comprising the electrocatalyst according to any one of Embodiments 1 to 36, preferably whereby the process produces a current density of 10 mA cm⁻² at an overpotential of about 200 mV or less, more preferably at 196 mV or less, preferably in a 1.0 M KOH electrolyte, for example, as determined by linear sweep voltammetry (LSV).
Embodiment 47. A process for electrocatalytic electrolysis of alkaline water, preferably producing a current density of 10 mA cm⁻² at an overpotential of about 1.55 V or less, preferably about 1.52 V or less, preferably in a 1.0 M KOH electrolyte as a test method, or a 1-6 M KOH solution, for example, as determined by linear sweep voltammetry (LSV), the process comprising the steps of:
   carrying out a hydrogen evolution reaction (HER) in a cell comprising the electrolyte and an electrode comprising the electrocatalyst according to any one of Embodiments 1 to 36, and in the same cell,
   carrying out an oxygen evolution reaction (OER) at an anode comprising the electrocatalyst according to any one of Embodiments 1 to 35.
Embodiment 48. A process for electrocatalytic hydrogen (H₂) gas generation from a seawater electrolyte, comprising the step of:
   carrying out a hydrogen evolution reaction (HER) in a cell comprising the electrolyte and an electrode comprising the electrocatalyst according to any one of Embodiments 1 to 34, preferably whereby the process produces a current density of 10 mA cm⁻² at an overpotential of about 40 mV or less, more preferably about 35 mV or less for example, as determined by linear sweep voltammetry (LSV).
Embodiment 49. A process for electrocatalytic oxygen (O₂) gas generation from a seawater electrolyte comprising the step of:
   carrying out an oxygen evolution reaction (OER) in a cell comprising the electrolyte and an electrode comprising the electrocatalyst according to any one of Embodiments 1 to 36, preferably whereby the process produces a current density of 10 mA cm⁻² at an overpotential of about 360 mV or less, more preferably at 350 mV or less, for example, as determined by linear sweep voltammetry (LSV).
Embodiment 50. A process for electrocatalytic electrolysis of seawater water, preferably producing a current density of 10 mA cm⁻² at an overpotential of about 1.55 V or less, for example, as determined by linear sweep voltammetry (LSV), the process comprising the steps of:
   carrying out a hydrogen evolution reaction (HER) in a cell comprising the electrolyte and an electrode comprising the electrocatalyst according to any one of Embodiments 1 to 36, and in the same cell,
   carrying out an oxygen evolution reaction (OER) at an anode comprising the electrocatalyst according to any one of Embodiments 1 to 36.
Embodiment 51. A process according to any one of Embodiments 45 to 50, involving seawater as electrolyte and chlorine evolution reaction (CER) and accompanying production of chlorine is avoided.
Embodiment 52. Use of a transition metal foam which free of molybdenum as a pore template and source of transition metal atoms in conjunction with an organic source of heteroatom dopant in the synthesis of ultra-thin 2D defect rich porous sheet of:
   a thermally phosphorized heteroatom doped-transition metal molybdenum oxide; or
   a heteroatom doped-transition metal molybdenum phosphide.
Embodiment 53. Use of Embodiment 52, wherein the transition metal foam free of molybdenum is a nickel foam, an iron foam or a cobalt foam, preferably a nickel foam, and wherein the organic source is hexamethylenetetramine as a source of nitrogen atoms.
Embodiment 54. Use according to Embodiment 52 or Embodiment 53, wherein the synthesis involves reacting a transition metal foam which is free of molybdenum, preferably nickel foam, and an organic source of heteroatom, preferably hexamethylenetetramine, in the presence of a peroxomolybdic solution in a hydrothermal process, followed by annealing, and a subsequent thermal phosphorization step to generate a phosphide product in the form of ultra-thin 2D defect rich porous sheets.
Embodiment 55. A method of synthesizing ultra-thin 2D defect rich porous sheets of a heteroatom doped-transition metal molybdenum phosphide, comprising the steps of:
   combining a peroxomolybdic solution, a non-molybdenum transition metal foam, and with an organic source of heteroatoms to form a first reactant solution;
   hydrothermally reacting the first reactant solution and recovering a dry solid powder product on completion of the hydrothermal reaction;
   annealing the dry solid powder under an inert atmosphere to form an annealed powder material;
   phosphorizing the annealed powder material with a source of phosphorus under an inert atmosphere to from the ultra-thin 2D defect rich porous sheets of a heteroatom doped-transition metal molybdenum phosphide.
Embodiment 56. The method of Embodiment 55, wherein the non-molybdenum transition metal foam is nickel foam.
Embodiment 57. The method of Embodiment 55 or Embodiment 56, wherein the organic source of heteroatoms is hexamethylenetetramine (HMTA), preferably a solution of hexamethylenetetramine (HMTA).

### EXAMPLES

The present invention is described with reference to the following examples. It is to be understood that the examples are illustrative of and not limiting to the invention described herein.

### Example 1. Preparation of N—NiMo₃P Electrocatalyst

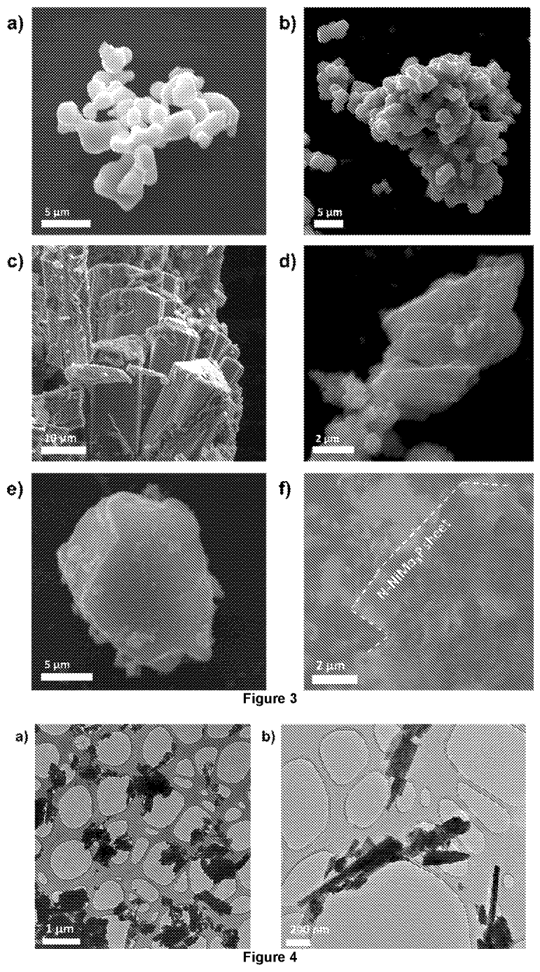

Porous sheets of N—NiMoO₃ and N—NiMo₃P were synthesized via a facile hydrothermal process followed by phosphorization as an efficient catalyst for alkaline seawater splitting, as illustrated in FIG. 26. The nickel foam served a dual function both as a source of nickel and a template to produce porous sheets of several microns. The hexamethylenetetramine (HMTA) acts as the nitrogen source to generate an M-N bond to increase the overall electrical conductivity, intrinsic activity, and anti-corrosive properties. Intermediate annealing was carried out to remove excess oxygen and water molecules, which facilitated better phosphorization and produced a defect-rich structure by tuning the chemistry at the crystallite grain boundaries. Hence, the annealing process enriches the catalyst with active sites through grain boundary engineering and removing adsorbed species at dangling bonds present at pores and edges. This extended electrode/electrolyte interface creates a foundation for an ideal catalyst for direct seawater splitting. The impact of annealing on crystal structure modification is observed through a transmission electron microscope (TEM) imaging of as-synthesized, annealed, and phosphorized samples, as shown in FIG. 2. The annealing provides the required energy to re-join the small sheets to form larger sheets, introducing additional grain boundaries that will act as active sites with distinct energy differences and will be hotspots for water adsorption and hydrogen desorption. FIG. 3 shows SEM images of MoO₃ (a), N—MoO₃ (b), and N—NiMoO₃ without (c) and with Ni foam (d), N—NiMo₃P (e), and N—NiMo₃P (f) after testing in seawater electrolyte. The SEM images clearly show that flake-like morphology was observed without the addition of Ni, while a rod-like morphology was observed after adding Ni powder, whereas, with the addition of Ni foam, sheet-like morphology was observed. The sheet morphology was retained after phosphorization and after electrochemical testing in seawater electrolyte.

### Example 2. Morphological Features

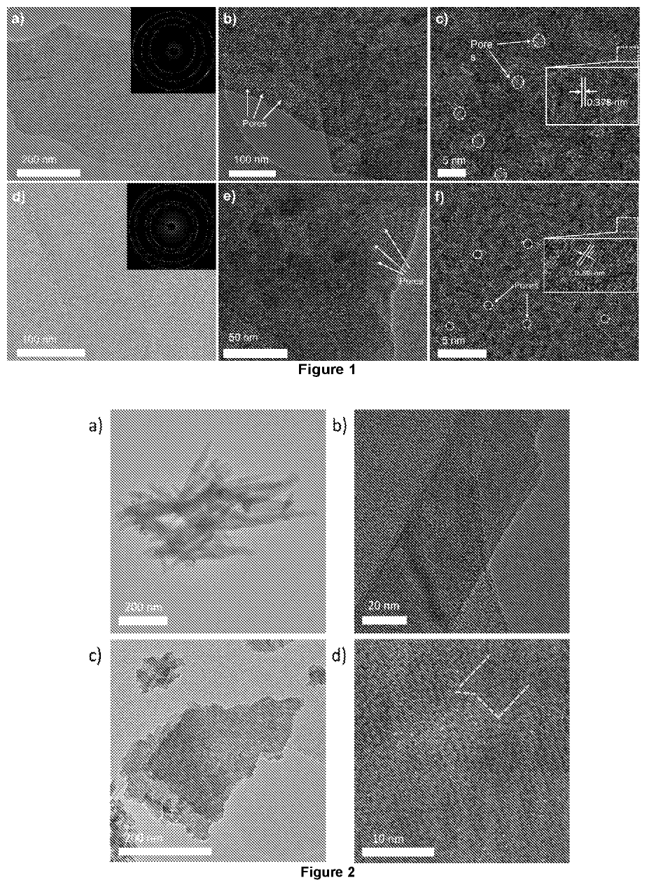

The TEM images in FIG. 1 show detailed morphological features and the texture of annealed N—NiMoO₃ and N—NiMo₃P sheets, where it is obvious that both samples possess ultrathin features and large lateral dimensions up to several microns. Furthermore, the TEM images clearly show the presence of homogeneously distributed pores (FIGS. 1b and 1e), indicating the formation of highly porous sheets. The existence of dangling bonds at pores creates new active sites and provides easy access through open pathways for mass transfer. The HMTA and nickel foam play a role in developing such defect-rich porous sheets, as HMTA releases NH₄⁺ ions, which bind with Mo atoms and cause exfoliation and form ultrathin sheets, which upon annealing, results in nitrogen doping. The nickel foam acts as a template for the growth of porous sheets. Its inherent pore structure, under high pressure and oxidative conditions, leave its footprints; as such, no sheet formation occurred, and pores are not observed in the absence of nickel foam (FIG. 4). On annealing, the loosely attached sheets connect and introduce larger grain boundaries, evident from the polycrystallinity of N—NiMoO₃ (the inset of FIG. 1a) and N—NiMo₃P (the inset of FIG. 1d) confirmed by selected area electron diffraction (SAED) results and support the observation of FIG. 2. As the crystallite's edges were rich with NH₄⁺ ions, which on annealing, leave nitrogen doping at grain boundaries, making them special active sites with distinct energy to work in harsh seawater. Further, the microstructure was evaluated by conducting a high-resolution TEM (HRTEM) analysis. The lattice spacing of 0.378 nm for N—NiMoO₃ corresponds to the (110) plane of MoO₃ according to JCPDS No. 35-0609 (FIG. 1c), and 0.239 nm for N—NiMo₃P corresponds to the (002) plane of Mo₃P according to JCPDS No. 89-2587 (FIG. 1f), confirming successful conversion to phosphide. Interestingly, the HRTEM image of both samples clearly shows the defects in the crystal structure caused by the pores and hetero-atom doping, marked by circles.

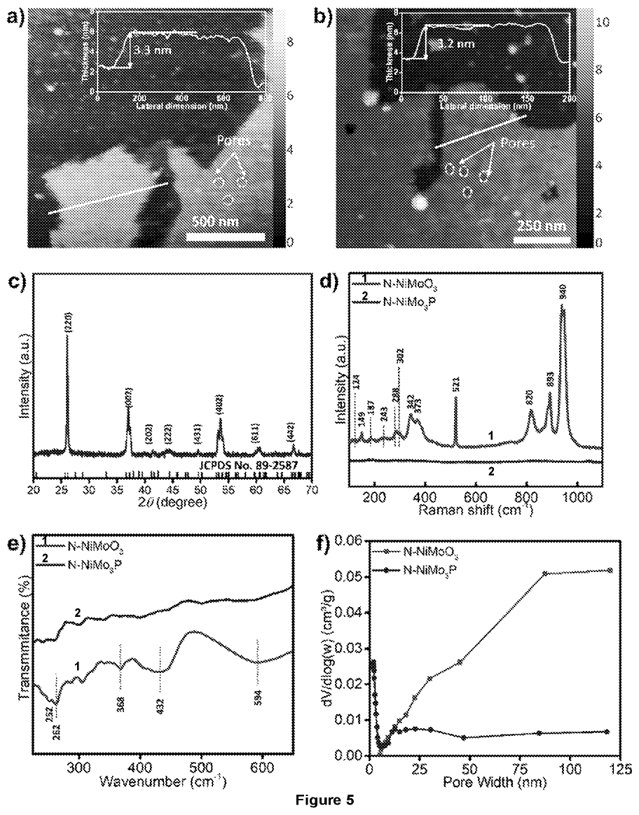

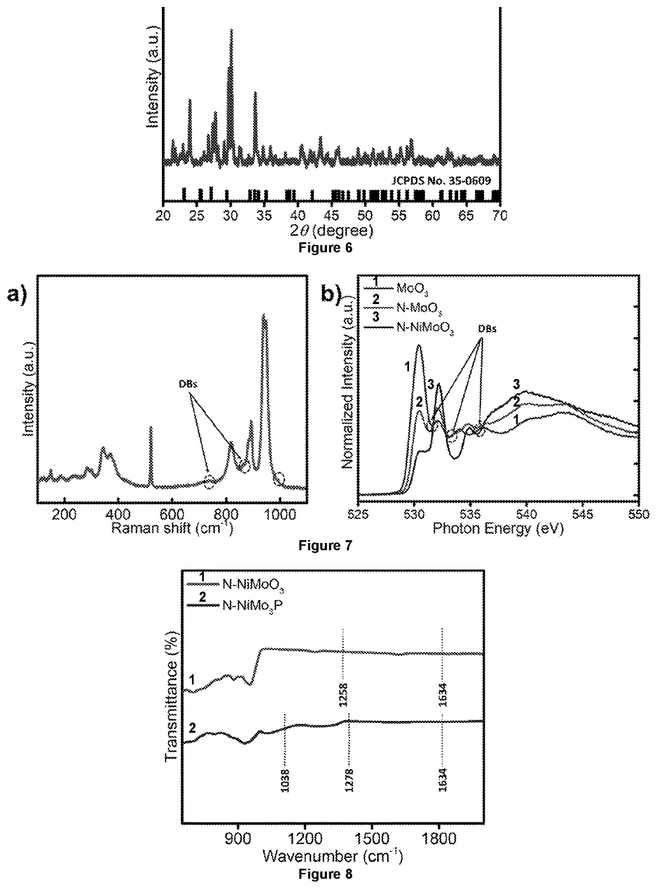

The atomic force microscope (AFM) confirmed the formation of large sheets having evidence of pores and ultrathin features of the as-synthesized sheets of N—NiMoO₃ and N—NiMo₃P, shown in FIGS. 5a and 5b, respectively. The thickness of oxide and phosphide sheets calculated using topological images are 3.3 nm (inset of FIG. 5a) and 3.2 nm (inset of FIG. 5b), respectively. After confirming the morphological aspects, the bulk crystal structure was analyzed using X-ray diffraction (XRD), where the pattern from N—NiMoO₃ indicates that molybdenum is the main crystal defining element, matches with the α-MoO₃ (JCPDS No. 35-0609), shown in FIG. 6 but with a small shift observed due to the introduction of N and Ni. Upon phosphorization, new peaks emerge at 26, 37, 41.5, 44, 49.5, 53.5, 60.5, and 66.6°, corresponding to the crystal planes (220), (002), (202), (222), (431), (402), (611), and (442) of Mo₃P, respectively (JCPDS card No. 89-2587), without any traces of oxide (FIG. 5c).

The XRD observations were further supplemented by Raman spectroscopy analysis (FIG. 5d), where N—NiMoO₃ shows peaks at 243, 288, 342, 373, and 820 cm⁻¹ ascribed to α-MoO₃. A peak at 940 cm⁻¹ could be attributed to the terminal Mo═O bond stretching mode of the amorphous MoO₃ phase. This also indicates the presence of metal-oxygen bond stretching mode for the oxide for dangling bonds. These dangling bonds are a result of the pores created during the heat treatment (FIG. 7a). These results again indicate that MoO₃ is the structure-defining component, as suggested by the XRD results. An average shift of 4 cm⁻¹ was observed compared to the reported values, which could well be due to the defects as a result of nitrogen doping and the addition of Ni. Interestingly, no peaks were recorded for N—NiMo₃P, confirming the successful conversion of oxide into phosphide.

Far-infrared Fourier-transform infrared spectroscopy (FIR-FTIR) measurements were carried out to analyze the surface chemistry (FIG. 5e). The N—NiMoO₃ sample shows strong peaks of 432 and 594 cm⁻¹ in the spectral range of 400-650 cm⁻¹, and further peaks at ~252, 262, and 368 cm⁻¹ are attributed to metal-oxygen bonds. Almost all of these peaks disappeared in FIR-FTIR spectra of N—NiMo₃P, showing the successful conversion of the oxide into phosphide. Moreover, the vibrations at ~1258 and ~1634 cm⁻¹ confirm the presence of nitrate and hydroxyl groups in the N—NiMoO₃ sample (FIG. S6). While new peaks at ~400 and ~10³⁸ cm⁻¹ appear in the case of N—NiMo₃P, attributing to the phosphate ion along with broader peaks at ~1278 and ~1634 cm⁻¹, indicating the presence of phosphate/nitrate and hydroxyl groups, respectively, which could be useful to protect the catalyst from anions attack (chloride present in seawater) and optimize surface for cation absorption.

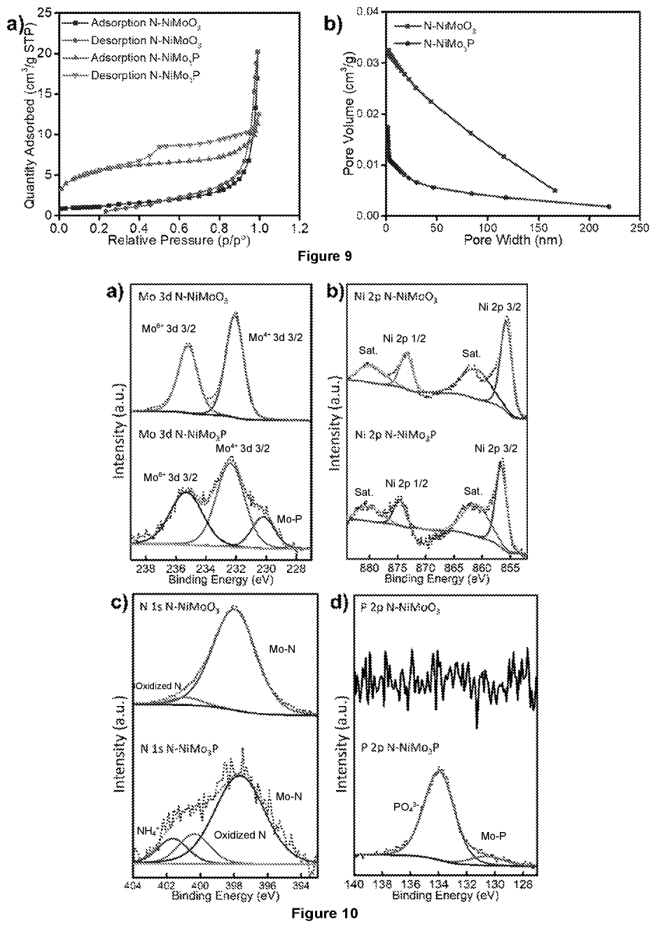

Considering the highly porous nature of the as-synthesized sheets, the nitrogen adsorption/desorption isotherms were recorded, as shown in FIG. 9a. Applying Brunauer-Emmett-Teller (BET) analysis, the surface areas for the oxide and phosphide were calculated to be 3.99 m² g⁻¹ and 19.29 m² g⁻¹, respectively. The increased surface area after phosphorization could be attributed to the redistribution of pores from macro to meso size, as evident from the pore distribution shown in FIG. 5f. The average pore diameter is decreased from 1.28 to 1.06 nm as shown by the pore size distribution curves in FIG. 9b; however, the pore volume is increased from 1.28×10⁻³ to 5.10×10⁻³ cm³ g⁻¹ upon oxide conversion to phosphide. It might be due to annealing which removes any unreacted compounds and helps in increasing the volume of the catalyst, and after phosphorization the pore size decreases due to the edge reaction with phosphorus. Such mass redistribution relating to the pores means their internal structure increases the surface area and makes these pores more active and easily accessible by molecules/ions and for solvation. This contributes positively toward the material activity.

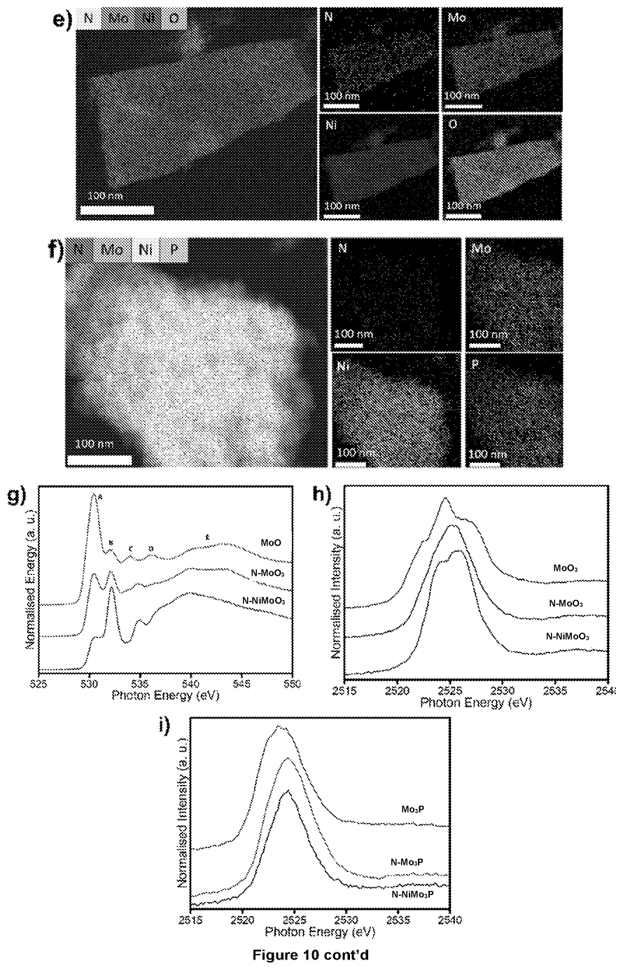

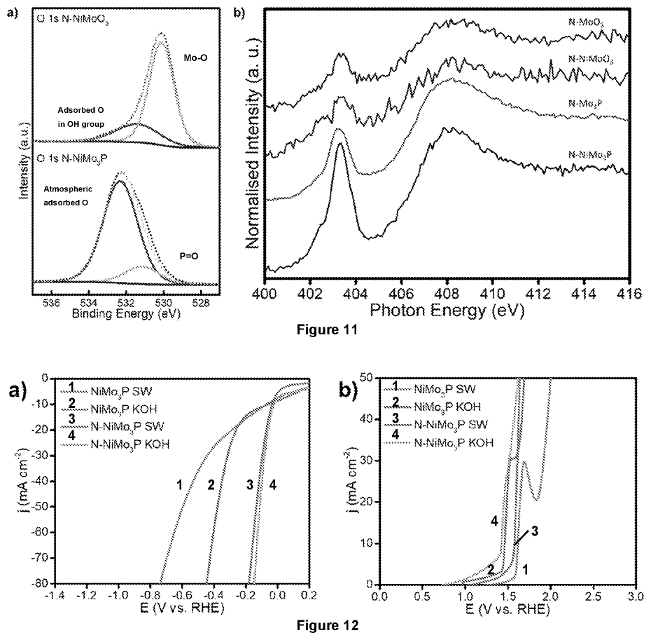

Oxidation states of the atoms within a catalyst play an important role in determining the activity and stability, which are determined by X-ray photoelectron spectroscopy (XPS). FIG. 3a presents the Mo 3d deconvoluted spectra of both oxide and phosphide, showing two major peaks around 235.2 and 232.1 eV could be attributed to 3d_{3/2} (Mo⁶⁺) and 3d_{3/2} (Mo⁴⁺), respectively. Interestingly a new peak appears in Mo 3d after phosphorization at 230.2 eV, corresponding to the Mo—P bond in N—NiMo₃P. Similarly, Ni 2p deconvoluted spectra of oxide show prominent peaks around 855.7 and 873.5 eV, attributed to Ni 2p_{3/2} and Ni 2p_{1/2} and their satellites at 861.1 and 879.5 eV, respectively, showing the presence of Ni²⁺ state. However, the Ni 2p_{3/2} and Ni 2p_{1/2} peaks are shifted by 1 eV without impacting the position of the satellites in N—NiMo₃P, which could be due to metal phosphorization (FIG. 10b). The deconvoluted N 1s spectra of both N—NiMoO₃ and N—NiMo₃P show the main peak around 397.8 eV, corresponding to the metal-nitrogen bond, while the oxide shows a second peak at 400.8 eV for oxidized-N species and the phosphide shows its other peaks at 400.4 and 401.6 eV corresponding to oxidized-N species and NH₄⁺ ions (FIG. 10c). The deconvoluted P 2p spectrum of N—NiMo₃P reveals peaks at 130.56 and 133.9 eV, ascribing to the M-P bond, and PO₄³⁻ could be formed due to the slight surface oxidation (also observed in FTIR) (FIG. 10d). The deconvoluted O 1s spectrum from N—NiMoO₃ shows peaks at 530.5 and 531.4 eV due to the formation of a metal-oxygen bond and oxygen in adsorbed OH group, respectively. The deconvoluted O 1s spectrum of phosphide has peaks at 531.14 and 532.3 eV resulting from the phosphorus-oxygen bond (phosphate) and atmospheric adsorbed oxygen (FIG. 11a). It is worth noting that a slight shift in the position of the peaks could be due to a redistribution of electrons created by defects, nitrogen doping, and the electronic structure's enhancement due to the synergistic effect between Ni and Mo in both systems. Hence, XPS results confirmed that Ni and N doping helps to tune the energy state of Mo as well as confirm the presence of surface phosphate and nitrates, which collectively tune the surface for efficient water catalysis and protection from corrosive chlorine chemistry.

To observe the distribution of elements across the different sheets, energy dispersive spectroscopy (EDS) elemental maps were recorded. These indicate the uniform distribution of N, Ni, Mo, and O throughout N—NiMoO₃ (FIG. 10e) and N, Ni, Mo, and P throughout N—NiMo₃P (FIG. 10f). These results confirm that each element is homogeneously distributed across the entire sheets, thus, helping in modulating the material's properties to achieve the maximum activity.

As XPS and EDS are surface characterization techniques, therefore, inductively coupled plasma mass spectroscopy (ICP-MS) studies were conducted to evaluate the nickel contents, which showed that the Ni is ~18.4% in N-NiMO₃P (Table 1). Specifically, Ni and Mo were 14.2±1.9 and 62.9±9.9 ppb, respectively. The high concentration of Ni assures that it is not simply a dopant but a part of the structure that tunes the electron density of Mo in the d-band and modifies the energy states, creating favorable sites for water adsorption and hydrogen/oxygen desorption.

To further explain the redistribution of charge states, the regulation of electron density of the metal and non-metals involved, and the tuning of the metal-non-metal bond, Near Edge X-ray Absorption Fine Structure (NEXAFS) analysis was done. FIG. 10g presents the O-Kedge NEXAFS spectra of the oxide samples. The O K-edge spectra display prominent spectral features marked A to D, corresponding to the Mo⁴⁺ state, while the E region corresponds to the Mo⁶⁺ state. It can be observed that the introduction of N and Ni in MoO₃ redistributes the electrons, as evident from the shift in photon energy around C and E and the disappearance of D. Furthermore, the dangling bonds can also be observed in the O K-edge spectra of MoO₃, N—MoO₃, and N—NiMoO₃ represented by FIG. 7b where the excitation of these energy states near the Mo⁴⁺ oxidation state stretching mode is in line with the metal-oxygen bond stretching mode for oxide as observed by the Raman spectroscopy results.

FIGS. 10h and 10i show the NEXAFS Mo L-edge for oxides and phosphides with and without the addition of Ni and N. It can be observed that the edge positions of Mo L-edge have displaced to a higher photon energy after the addition of both Ni and N atoms as compared to the original MoO₃ and Mo₃P. This shift indicates that Mo in N—NiMoO₃ and N—NiMo₃P are in a higher oxidation state than that in MoO₃ and Mo₃P, respectively indicating the higher oxidation state of Mo and changes in the Mo charge density after N and Ni addition. Additionally, the d orbitals of Mo atoms tend to support the fast transfer of electrons with a low energy barrier. Due to the rapid transfer of electrons, Mo⁴⁺ oxidizes to Mo⁶⁺, which favors the formation of more active phases during the reaction (like the oxyhydroxide phase during OER) and leads to a stronger interaction with the adsorption intermediates. Furthermore, the addition of N and Ni also makes the Mo species flexible during the oxidation-reduction cycles, which also enhances the adsorption of intermediates. Furthermore, the presence of neighbouring Ni sites uplifts the d-band centre of the Mo sites leading to a better transfer of electrons, and this rapid transfer of electrons is essential for improving the adsorption of intermediates and for better performance.

Although the N K-edge spectra of the N—MoO₃ and N—NiMoO₃ show very small to negligible shift in the photon energy; however, the peak in MoO₃ is broader, which means N atoms are strongly coordinated with Mo, while after the addition of Ni, the peak is less broad indicating that the bond between N and Mo weakens. This can be justified by the phosphide N K-edge spectra as well, which demonstrate the same behaviour after the addition of Ni (FIG. 11b). These results justify that the introduction of N and Ni changes the oxidation state and hence the electron densities of Mo as well as helps in tuning the metal-non-metal bond length.

### Example 3. Electrochemical Studies

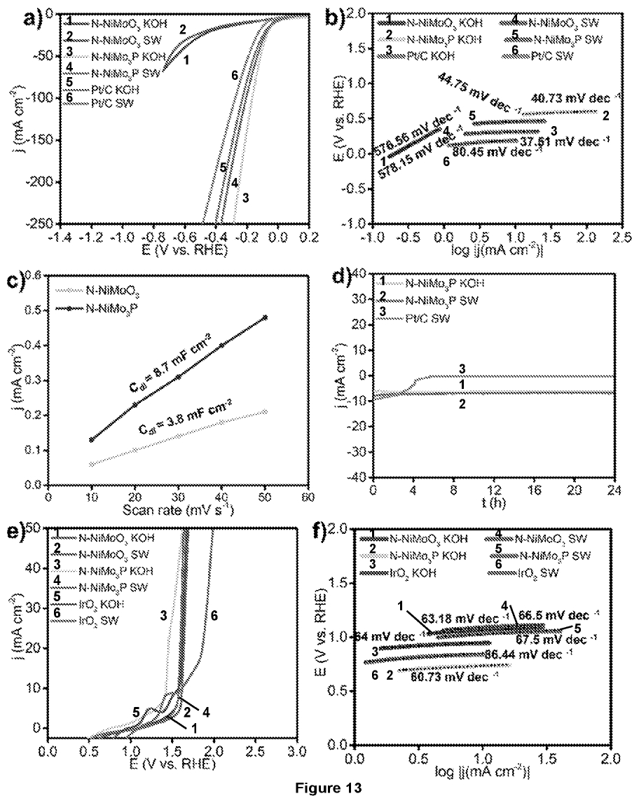

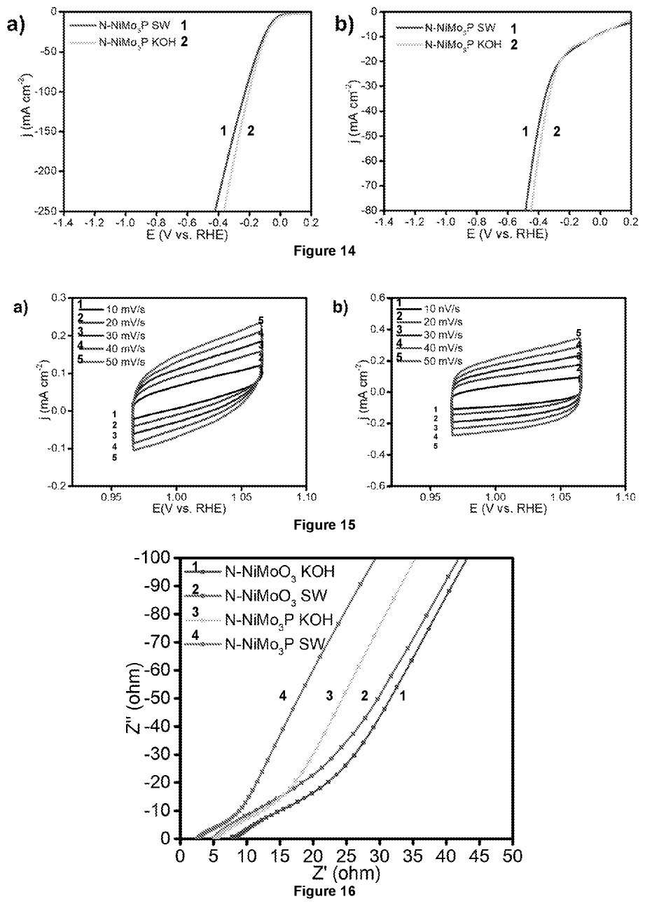

Considering the unique chemical composition and structure, as-synthesized samples were initially analyzed for HER in 1.0 M KOH and real seawater from St. Kilda beach in Melbourne, Australia. The linear sweep voltammetry (LSV) results showed that N—NiMo₃P demonstrated exceptional HER activity having low overpotentials of 23 and 35 mV to achieve a current density of 10 mA cm⁻² in 1.0 M KOH and seawater, respectively (FIG. 13a). This performance is not only better than the commercial Pt/C, which required 22.5 and 73.5 mV to achieve 10 mA cm⁻² in 1.0 M KOH and seawater, respectively, but also puts N—NiMo₃P among the best catalysts tested to date for direct seawater catalysis (Table 3). To study the impact of nitrogen doping on the performance of the catalyst, electrochemical testing of NiMo₃P was also done. NiMo₃P required an overpotential of 61 and 73 mV in 1.0 M KOH and seawater electrolyte which is higher as compared to the overpotential required by N—NiMo₃P, indicating that nitrogen doping significantly improves the performance of the catalyst (FIG. 12a). However, the oxide sample did not demonstrate good HER activity as expected and required 183.5 and 218.5 mV to achieve 10 mA cm⁻² in 1.0 M KOH and seawater, respectively. This could be due to the low intrinsic affinity of oxides for HER. To understand the reaction kinetics, Tafel plots were obtained, which showed a Tafel value of 40.73 mV dec⁻¹ for N—NiMo₃P, almost the same as of Pt/C (37.51 mV dec⁻¹) in 1.0 M KOH; however, the Tafel value of our sample (44.75 mV dec⁻¹) is as low as half of Pt/C (80.45 mV dec⁻¹) in real seawater (FIG. 13b). The Tafel values of oxides (578.15 and 576.56 mV dec⁻¹ in 1.0 M KOH and seawater, respectively) were comparatively higher. Thus, proving that N—NiMo₃P bears not only low overpotentials but also shows high reaction kinetics making it a potential candidate for direct seawater splitting. This outstanding performance of N—NiMo₃P is based on its engineered composition, where the M-P bond has been altered and elongated by N doping which creates +δ and −δ charges as active hot spots to absorb the intermediates and improve the reaction kinetics by optimizing the surface energies for effective catalysis. For comparison, the overpotentials were also reported without doing IR compensation, as shown in FIG. 14a, and the catalyst required 29 and 41 mV to achieve 10 mA cm⁻² in 1.0 M KOH and seawater electrolyte. The electrochemical testing was also done on carbon paper electrodes to eliminate any effect of Ni foam, and the reported overpotentials for the same were 33 and 40 mV (FIG. 14b).

To probe the role of surface area, the electrochemical active surface was predicted by measuring the double-layer capacitance (C_{dl}) of N—NiMoO₃ (3.8 mF cm⁻²) and N-NiMO₃P (8.7 mF cm⁻²), which shows that phosphide has a higher active surface and support the measurements of BET analysis (FIG. 13c, 15). This indicates the existence of abundant active sites in N—NiMo₃P, contributing to its excellent HER performance. Further, electrochemical impedance spectroscopy (EIS) was performed to understand the role of nitrogen and Ni as well as pores in improving the electrochemical performance of N—NiMo₃P (FIG. 16). It is observed that N-NiMO₃P faces the smallest electrolyte resistance, which is slightly higher in seawater than in freshwater could be due to higher ionic concentration in seawater. Similarly, N—NiMo₃P also bears a smaller semi-circle than the oxide counterpart, which shows lower charge transfer resistance. These improved conductivities are due to the presence of nitrogen and nickel, which ensured enough electronic movements in the catalyst structure. Furthermore, lower Warburg (W) resistance was also observed for N—NiMo₃P, which shows faster ionic movements due to the pore-rich structure of sheets (FIG. 16). Hence, improved conductivities and faster mass transport contributed to the enhanced electrochemical performance of N—NiMo₃P.

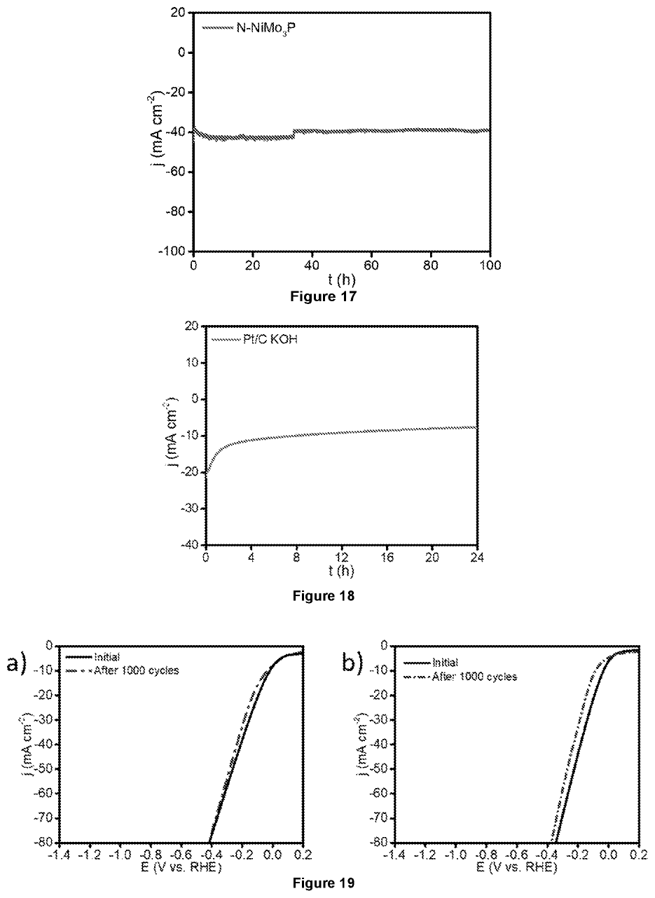

Stability is one of the most critical factors in judging long-term performance; therefore, an amperometric test of N—NiMo₃P was conducted in 1.0 M KOH and real seawater. As evident from FIG. 13d, the hydrogen production activity of N—NiMo₃P in 1.0 M KOH (retains 98% of its catalytic current density) and seawater (retains 82% of its catalytic current density) was exceptionally stable for 24 h. A further stability test of 100 h was also conducted in 1.0 M KOH to confirm the exceptional stability of the material, as shown in FIG. 17. In comparison, Pt/C has very poor stability as it retains less than 5% of its catalytic current density over the same time duration in seawater electrolyte and losses more than half of its initial current density in 1.0 M KOH (FIG. 4d, 18). In addition, the polarization curves of the catalyst before and after 1000 cyclic voltammetry (C—V) cycles almost overlap in 1.0 M KOH (FIG. 19a) and seawater (FIG. 19b), indicating the excellent stability of the catalyst in both electrolytes.

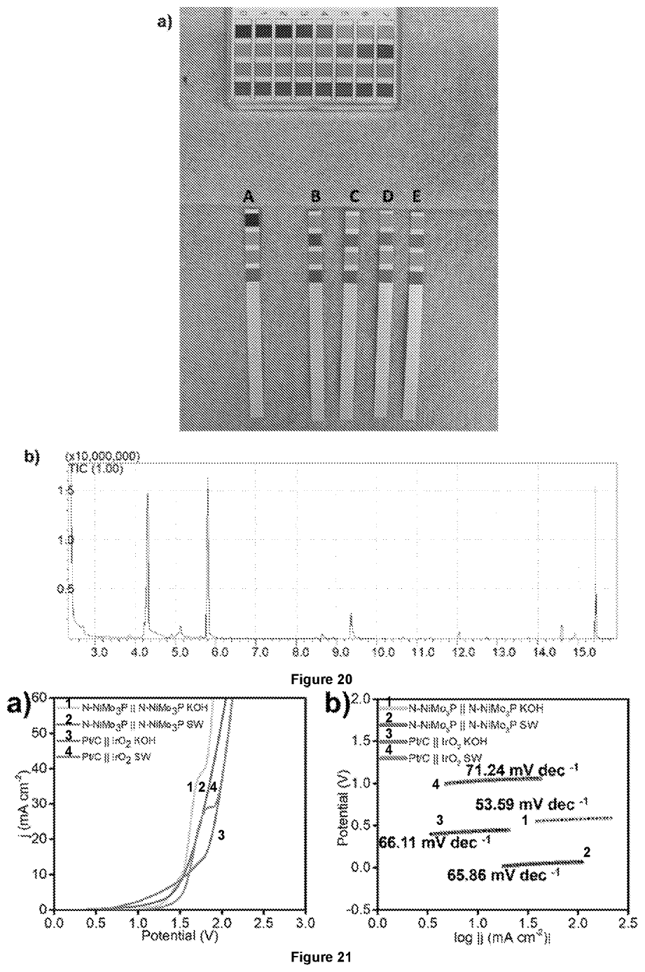

To be bifunctional catalysts for full water splitting, the catalysts should be capable of carrying out both anodic and cathodic reactions in the same electrolyte. Therefore, LSV curves are recorded for as-synthesized materials to evaluate their OER performance and suitability in seawater. The N—NiMo₃P delineated an exceptional OER activity, where it achieved a current density of 10 mA cm⁻² at overpotentials of only 196 and 346 mV, better than the commercial IrO₂, which required 313 and 385 mV to achieve 10 mA cm⁻² in 1.0 M KOH and seawater, respectively (FIG. 13e). The impact of nitrogen doping was also studied by carrying out electrochemical testing of NiMo₃P. NiMo₃P required an overpotential of 233 and 386 mV in 1.0 M KOH and seawater electrolyte, indicating that nitrogen doping significantly improves the performance of the catalyst (FIG. 12b). Interestingly, it is found that after nitrogen doping the strong oxidation peaks appearing in NiMo₃P both in KOH and seawater electrolytes also disappears which signifies the role of nitrogen in improving the structural stability and inhibiting the corrosion of catalysts. Additionally, N—NiMoO₃ also showed excellent OER activity, which is comparable to commercial IrO₂ as it only required overpotentials of 343 and 386 mV in 1.0 M KOH and seawater to achieve 10 mA cm⁻², respectively. More importantly, the overpotential required by N—NiMo₃P in seawater is significantly smaller than the 490 mV overpotential required to initiate the CER and thus prevent the formation of hypochlorite, where surface modification by polyanions will further assist in avoiding CER. As, it has been reported that polyanions with moderate ionic potential such as phosphate ions are highly favourable to repel the chloride ions without impacting the active sites and protect the catalyst surface from corrosion and favour the adsorption of water molecules and promote the reaction kinetics.^{[13]} To further prove that there was no CER at the anode, electrochemical testing was done continuously to generate gas over the working electrode, which was then passed through acetone at room temperature. The reaction between chlorine gas and acetone is instantaneous and gives chloroacetone and HCl. The chlorine reacts quantitatively with acetone with zero concentration of chlorine at the outlet. However, when the gas collected from the cell was passed through acetone, no such reaction was observed, confirmed qualitatively by the pH test of the solution (FIG. 20a). For further quantitative confirmation of chlorine selectivity, a gas chromatograph mass spectrometer (GC-MS) was used to analyze the acetone+gas mixture. FIG. 20b shows that the peaks obtained after the GC-MS of the solvent correspond majorly to acetone except for the sharp peak around 6, which attributes to the internal standard peak. Hence confirming that chlorine was not generated at the anode as no signals were found for chloroacetone, and developed catalysts show high selectivity towards OER and have the ability to suppress the CER, hence making it suitable for seawater catalysis.

Further, a much lower Tafel value of 67.5 mV dec⁻¹ for N—NiMo₃P than IrO₂ (86.44 mV dec⁻¹) in real seawater shows its superior reaction kinetics (FIG. 13f). The same trend is observed for Tafel values in an alkaline electrolyte where N—NiMo₃P (60.73 mV dec⁻¹) is performing better than IrO₂ (64 mV dec⁻¹). Interestingly, N—NiMoO₃ also showed better Tafel values (63.18 and 66.5 mV dec⁻¹ in 1.0 M KOH and seawater, respectively) than that of standard IrO₂. Hence, proving that structural and morphological manoeuvring of materials is highly beneficial in attaining efficient catalysis at low overpotentials.

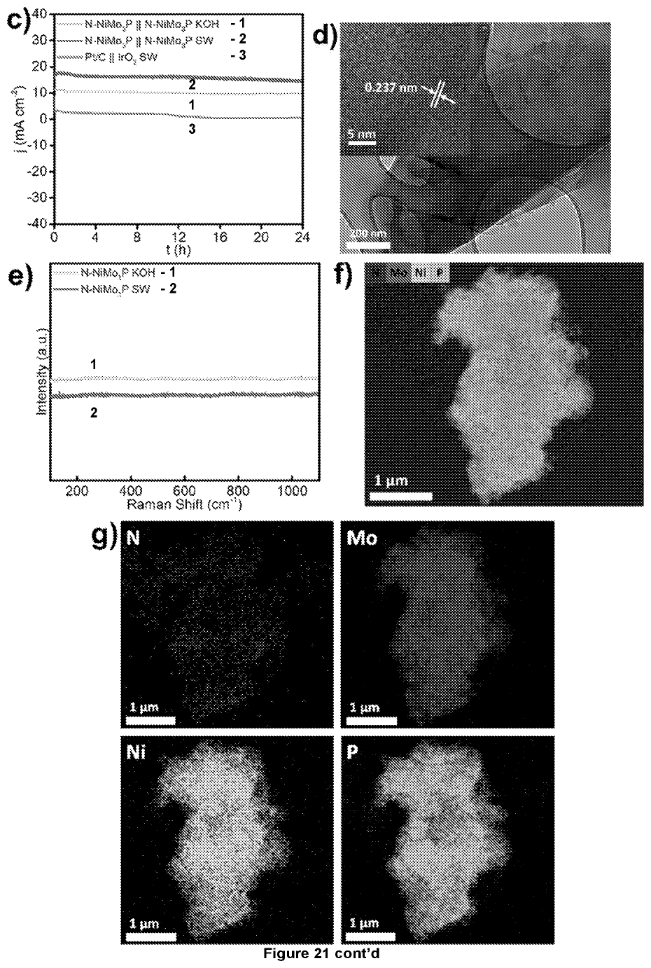

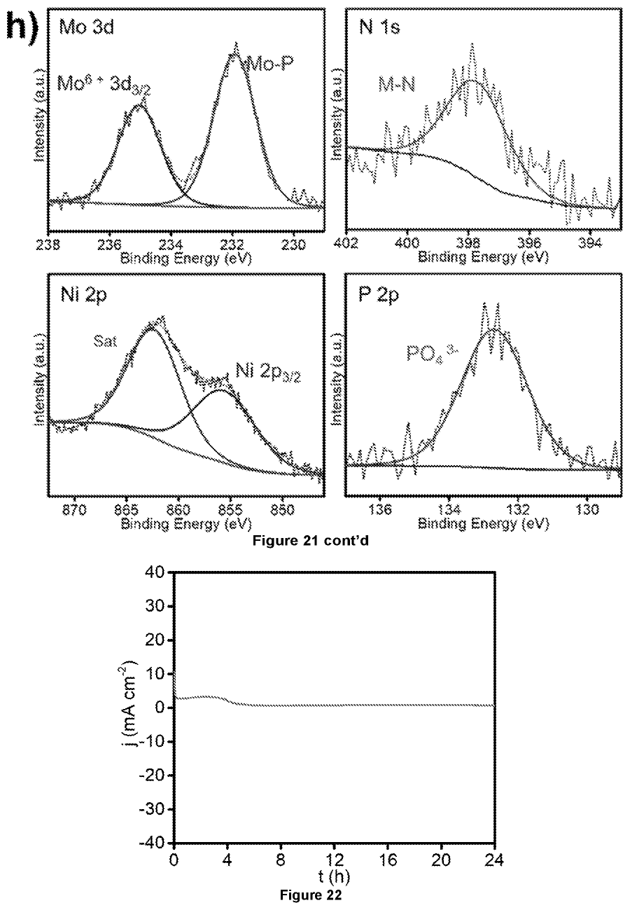

Finally, N—NiMo₃P was used as both the anode and cathode to carry out full water splitting in 1.0 M KOH and real seawater in a two-electrode system to explore its commercial applicability. The LSV curves of N-NiMO₃P∥N-NiMo₃P show an exceptional performance by achieving a current density of 10 mA cm⁻² at low total cell voltages of 1.52 and 1.55 V in 1.0 M KOH and seawater, respectively (FIG. 21a). This performance is not only better than the coupled benchmark Pt/C∥IrO₂ full cell that required a cell voltage of 1.584 and 1.607 V to achieve 10 mA cm⁻² in 1.0 M KOH and seawater, respectively, but also the best among the reported catalysts (Table 4). The Tafel plots further demonstrate much better reaction kinetics of N-NiMO₃P∥N-NiMo₃P (Tafel value of 53.59 and 65.86 mV dec⁻¹) than the coupled Pt/C∥IrO₂ (66.11 and 71.24 mV dec⁻¹) both in 1.0 M KOH and real seawater, respectively (FIG. 21b). To evaluate the long-term performance of the catalyst, an amperometric test of the N—NiMo₃P was conducted, where it retained 87% (1.0 M KOH) and 86% (seawater) of its catalytic current density for 24 h (FIG. 21c). In comparison, coupled Pt/C∥IrO₂ system showed very poor stability by retaining only <5% of its catalytic current density over the same time duration (FIG. 21c, 22).

This exceptional electrochemical performance of N—NiMo₃P is based on its unique composition, structure, morphology, and surface chemistry, which play key roles such as: i) N-doping manipulated the surface energy through tuning the metal-non-metal bond; ii) accelerated charge transfer and electronic redistribution of Mo by Ni (presence of N multiply the effect) making it more susceptible for H₂O adsorption and H₂ desorption; iii) negatively charged surface polyanions tune the surface energy for proton adsorption and more importantly act as repellent for chloride ions; iv) homogenous pores across the entire sheet assuring high mass transfer and introducing new active sites through dangling bonds present at pores; v) existence of large number of grain boundaries at the connecting point of crystallites to form large sheets and strain act as binding and active sites; and vi) finally the N-doping effectively stabilize the structure and regulate the intrinsic electroactive sites to promote the catalysis.

It is believed that these principles and effects will be applicable to other variations of the materials described here for other heteroatoms and non-Mo transition metals, wherein one or more of the following applies: the atoms/ions are of similar size, are isoelectronic to the examples provided herein, and/or have similar electronegativity, and/or oxidations states. All these features have been controlled with great care in the developed catalysts, and the resulting electrochemical response has proved their benefits; however, for long-term operations, these features should be stable with ongoing electrochemical activity on catalysts in the presence of harsh solvents. To monitor the preservation of the aforementioned features, a set of ex-situ characterizations have been utilized, such as XRD, TEM, Raman spectroscopy, STEM-EDS, ICP-MS, and XPS, after a continuous operation of 24 hours.

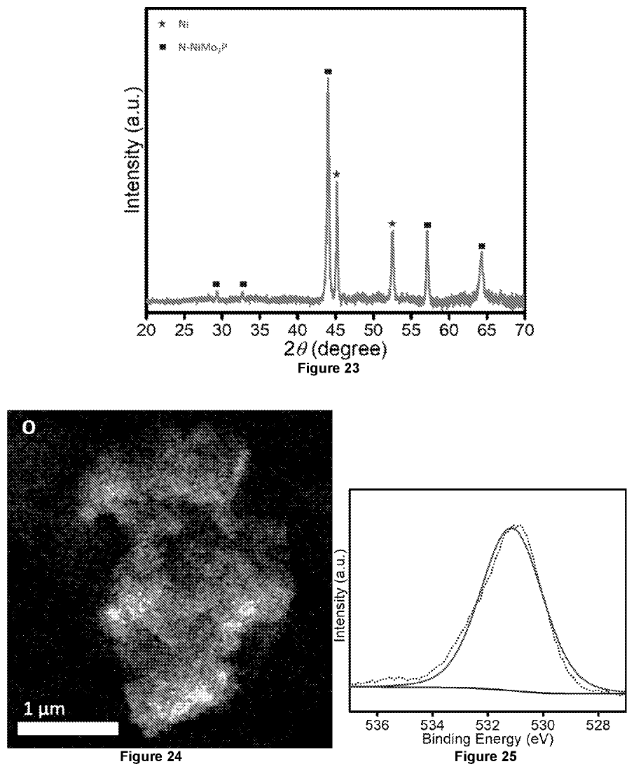

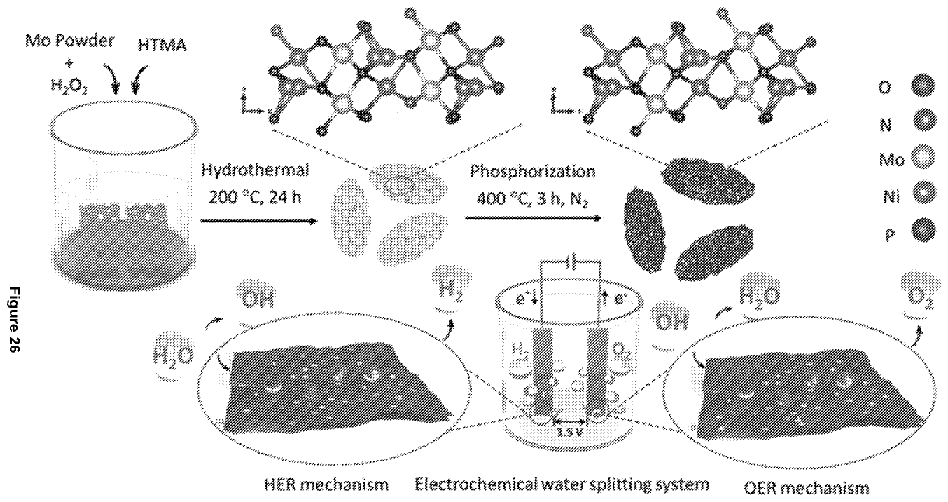

It is worth mentioning that the XRD of the electrode after HER testing (which is more susceptible for metal depositions) in seawater electrolyte demonstrated the same peaks (well-matched with standard JCPDS card No. 89-2587) as observed for the as-synthesized N—NiMo₃P, shown in FIG. 23. The XRD results indicated that there was no deposition of any foreign materials, which demonstrates that the impurities present in seawater do not impact the catalyst performance, and the structure of the catalyst was retained, which was also confirmed by the TEM results. The TEM image recorded after 24 h of operation clearly shows ultrathin 2D features without any lateral size reduction of N—NiMo₃P, confirming the material's high morphological and structural stability even in a harsh seawater environment (FIG. 21d). This also confirms that grain boundaries remain connected to keep the crystallite unified and active sites alive, as well as no material degradation occurs at the pore openings, which are generally more susceptible to a corrosive environment. Further, high structural stability also reveals that no CER and hypochlorite formation occurs, and catalysts are stable to accommodate any such minute product formation due to their unique surface chemistry and surface protection by negatively charged polyanions. Furthermore, Raman spectroscopy analysis also confirmed structural stability as no excessive oxidation of N—NiMo₃P is observed, which shows that controlled composition provides high phase stability (FIG. 21e). Interestingly, EDS analysis (FIGS. 21f and 21g) demonstrates the homogenous distribution of N, Mo, Ni, and P over the catalyst, and no deposition of Mg or Ca ions on the catalyst surface is observed, confirming its high selectivity towards proton and no parasitic attack of metal cations, hence supporting exceptional long-term stable operation of catalyst in seawater. FIG. 24 shows the elemental map of a thin oxygen layer that may be aroused from phosphorus-oxygen or nitrogen-oxygen species on the surface of the sample or due to the surface oxidation/adsorbed oxygen. Considering the limitation of EDS, we conducted an ICP-MS analysis of used catalyst which showed that no metals were deposited and the ratio of Ni/Mo in the catalyst remained same (Table 2). FIG. 21h shows the ex-situ XPS high-resolution spectra of Mo, Ni, P, and N for N—NiMo₃P. The Mo 3d deconvoluted spectra show two major peaks at 235 and 231.9 eV ascribing to a high oxidation state Mo⁶⁺ 3d_{3/2} and Mo—P bond; the existence of a high oxidation state and Mo—P make Mo a favourable site for catalysis. The Ni 2p deconvoluted spectra show two peaks at 855.6 and 862.3 eV that ascribe to the Ni 2p_{3/2} and its satellite, indicating the presence of Ni²⁺ state and no change occurred in its oxidation states showing Ni is continuously playing a role in stabilizing Mo active sites. The deconvoluted N 1s XPS spectra show a peak around 397.69 eV, attributed to the metal-nitrogen bond, which is crucial for providing anti-corrosive properties to the catalyst for continuous catalysis over a long time. The deconvoluted P 2p spectra of the sample show peak at 132.68 eV attributed to surface oxidation to yield phosphate species which act as a stabilizer against chlorine chemistry in conjunction with nitrate polyanions. The deconvoluted O 1s spectrum shows a peak at 531.14 eV arising from a phosphorus-oxygen bond (FIG. 25). The small shift in the peak positions remained the same as of original results i.e., due to the electron redistribution by defects, nitrogen doping, and the enhancement of electronic structure by Ni. Overall, these results strongly demonstrate that the catalyst's composition, surface, structure, and morphology remain intact, indicating its exceptional stability and performance in carrying out direct seawater catalysis.

### Example 4. Experimental Methods

### Synthesis of Nitrogen-Doped Nickel Molybdenum Phosphide

To prepare N—NiMo₃P, a sacrificial N—NiMoO₃ sample was first synthesized by a facile hydrothermal process. In detail, 500 mg of Mo powder was taken in a 20 mL glass vial to which 6 mL of 30% w/w hydrogen peroxide was added dropwise, leading to an exothermic reaction forming a yellow colour peroxomolybdic solution. In another 20 mL glass vial, 350 mg of hexamethylenetetramine (HMTA) (nitrogen source) was added to 10 mL DI water and mixed well to obtain a transparent solution. Following this, 320 mg of Ni foam was added to the peroxomolybdic solution along with the slow addition of the HMTA solution under continuous stirring for 30 min. The solution was transferred to a Teflon-lined stainless-steel autoclave, and a hydrothermal reaction was carried out at a temperature of 200° C. for 24 h, then cooled naturally to room temperature. The sample was washed twice with DI water and ethanol, and the resulting powder sample was dried overnight in a vacuum oven at 40° C. The dried sample was then annealed in a tube furnace under continuous nitrogen flow at a temperature of 350° C. for 2 h at the heating rate of 3° C./min. Finally, the sample was phosphorized at 400° C. with a heating rate of 3° C./min under a nitrogen atmosphere for 3 h. Sodium hypophosphite was used as the phosphorus source while keeping the ratio between the sample and the P source at 1:30.

### Example 5. Material Characterization

To analyze the morphology, crystal structure, and lattice imperfections, transmission electron microscope (TEM), high-resolution TEM analysis, and energy-dispersive X-ray spectroscopy (EDS) were done by using JEOL 2100F instrument. Surface topography analysis was done by using an atomic force microscope (AFM-Dimension Icon-Bruker) in scanasyst mode with a scanasyst tip, and the data was processed using gwyddion software. X-ray diffraction (XRD) analysis was done using a Bruker D4 Endeavor to obtain the crystal structure of the products. High-resolution X-ray photoelectron spectroscopy (XPS) was conducted by using a thermo-scientific K-alpha system. The system consists of an Al Kα monochromated X-ray source for scanning the samples at a dwell time of 50 ms⁻¹ and pass time of 50 eV. Raman spectra were obtained using a LabRAM HR evolution Raman spectrometer (Horiba Scientific) under a 532 nm laser with 50 mW power. Perkin Elmer Spectrum 100 far infrared Fourier-transform infrared (FIR-FTIR) spectroscopy was used to study the spectra ranging between 200 and 00 cm⁻¹. Brunauer-Emmett-Teller (BET) analysis was used to obtain the adsorption-desorption isotherms and pore volume distribution of the samples assisted by nitrogen gas using a Micromeritics Tristar II analyzer. The ICP-MS results were acquired by using the Agilent Inductively Coupled Plasma Mass Spectrometer (ICP-MS) with laser ablation capability. A CHI 760D electrochemical workstation (CH Instruments) was used for the electrochemical measurements. Near Edge X-ray Absorption Fine Structure (NEXAFS) data was acquired using the High Throughput NEXAFS endstation at the Soft X-ray beamline, Australian Synchrotron in Partial Electron Yield (PEY) mode using a retarding grid-based channeltron detector set to an appropriate bias for each element. The Gas chromatography was done using Varian Gas Chromatograph with single quadrupole mass spectrometer (GC-MS).

### Example 6. Electrochemical Measurements

The electrochemical testing of the as-prepared samples was done in 1.0 M KOH, and seawater electrolytes at ambient temperature and pressure using a CHI 760 D electrochemical workstation (CH Instruments) in which saturated Hg/HgO was used as the reference electrode, a graphite rod as the counter electrode, and the working electrode was prepared by drop-casting the samples on nickel foam which was washed with dilute HCl and water before electrode preparation. The polarization curves were recorded with a scan rate of 5 mV s⁻¹ after iR correction. Some polarization curves were also reported on C paper without iR correction for comparison. The powdered sample was added to the carbon black solution (4:1), followed by the addition of Polytetrafluoroethylene (PTFE) solution (60% in H₂O, sigma) and sonicated to form a homogeneous ink. The carbon black solution was prepared by adding 20 mg carbon to a 20 mL mixture of Isopropyl alcohol (IPA) and water (4:1). The solution was then sonicated for 1 h to acquire proper dispersion. Then, 200 μL of the ink was drop-casted onto an area of 0.25 cm² on nickel foam. For determining the electrochemical double-layer capacitance (C_{dl}), electrochemical cyclic voltammetry (CV) measurements were performed over a range of scan rates (10, 20, 30, 40, and 50 mV s⁻¹). Electrochemical impedance spectroscopy (EIS) was carried out over the frequency range of 1 to 10,000 Hz using an AC voltage of 5 mV amplitude. The stability tests were also performed at a fixed potential.

TABLE 1
Elemental composition of Ni and
Mo obtained from ICP-MS analysis.

| Catalyst | Ni (ppb) | Mo (ppb) | Ni/Mo |
|---|---|---|---|
| N—NiMoO₃ | 44.0465 | 183.829 | 0.19 |
| N—NiMo₃P | 14.25225 | 62.91475 | 0.184 |

TABLE 2
Elemental composition of metals in natural seawater, 1.0M KOH in seawater electrolyte,
and electrode tested in seawater obtained from ICP-MS analysis.

| Sample | Na (ppb) | K (ppb) | Mg (ppb) | Ca (ppb) | Ni (ppb) | Mo (ppb) |
|---|---|---|---|---|---|---|
| Natural seawater | 4759.775 | 38.95467 | 191.592 | 179.2077 | Below | Below |
| | | | | | detectable | detectable |
| | | | | | range | range |
| 1.0M KOH in | 6826.417 | 16960.99 | Below | Below | Below | Below |
| seawater | | | detectable | detectable | detectable | detectable |
| | | | range | range | range | range |
| Electrode tested | 1154.343 | 1898.088 | Below | Below | 5.2595 | 31.289 |
| in seawater | | | detectable | detectable | | |
| | | | range | range | | |

TABLE 3
Summary of HER performance of different
catalysts in alkaline media and seawater.

| | Overpotential | Overpotential |
|---|---|---|
| | (mV@ 10 mA cm⁻²) | (mV@ 10 mA cm⁻²) |
| Sample | (alkaline media) | (seawater) |
| N—NiMo₃P | 23 | 35 |
| N—FeMoP | — | 234 |
| Ni—SN@C | 28 | 23 |
| NiCoN\|NiₓP\|NiCoN | — | 165 |
| 2.4% Pt@mh-3D MXene | 27 | 280 |
| Ni-SA/NC | 102 | 139 |
| CoNiP/CoₓP | 36 | 290 |
| Ru—CuOₓ/NF | 20 | 49 |
| Ru_{1+NPs}/N—C | 39 | 58 |
| Mo₅N₆ | 94 | 257 |
| Mn—NiO—Ni/Ni—F | — | 170 |
| NPNNS | 87 | 144 |
| h-MoN@BNCNT | 118 | ~160 |
| Co_{0.31}Mo_{1.69}C/MXene/ | 75 | 306 |
| NC | | |
| Co—MoSe₂ | — | 274 |
| CoMoP@C | 81 | ~450 |
| (Ru—Co)Oₓ | 44.1 | — |
| CoRu_{0.5}/CQDs | 18 | — |
| Ni₅P₄—Ru/CC | 54 | — |
| P,W-Co₃N NWA/NF | 41 | — |
| Pt/MgO | 39 | — |
| RuO₂—300Ar | 17 | — |
| RuTe₂ | 34 | — |

TABLE 4
Summary of OER performance of different
catalysts in alkaline media and seawater.

| | Potential difference (V) | Potential difference (V) |
|---|---|---|
| Sample | (alkaline media) | (seawater) |
| N—NiMo₃P | 1.43 @ 10 mA cm⁻² | 1.58 @ 10 mA cm⁻² |
| N—FeMoP | 1.46 @ 100 mAcm⁻² | 1.55 @ 100 mAcm⁻² |
| N—FeMoO₃ | 1.48 @ 100 mAcm⁻² | 1.52 @ 100 mAcm⁻² |
| IrO₂ | 0.313 @ 10 mA cm⁻² | 0.385 @ 10 mA cm⁻² |
| | (overpotential) | (overpotential) |

TABLE 5
Summary of overall water splitting performance of
different catalysts in alkaline media and seawater.

| | Potential | |
|---|---|---|
| | difference | Potential |
| | (V@ 10 mA | Difference |
| | cm⁻²) (alkaline | (V@ 10 mA cm⁻²) |
| Sample | media) | (seawater) |
| N—NiMo₃P \|\| N—NiMo₃P | 1.526 | 1.55 |
| RuO₂—300Ar// RuO₂-300Air | 1.45 | ~1.85 |
| Ni NP\|Ni—N—C | 1.58 | — |
| PdP₂@CB | ~1.7 | — |
| Ni,Zn dual-doped CoO NRs | ~1.52 | — |
| Ru—CoOₓ/NF \|\| Ru—CoOₓ/ | 1.59 @ 100 | 1.86 @ 100 |
| NF | | |
| Ni₂P—Fe₂P/NF | 1.682 @ 100 | 1.811 @ 100 |
| RuTe₂ | 1.57 | — |
| CuFe/NF \|\| CuFe/NF | 1.64 | — |
| Co₉S₈/Cu₂S/CF | 1.6 | — |
| Ni—MoN/CF \|\| SSM | 1.613 @ 100 | 1.635 @ 100 |
| NiMoN/NF \|\| S—(Ni,Fe)OOH/ | 1.618 @ 100 | 1.661 @ 100 |
| NF | | |
| CoPₓ/NF \|\| CoPₓ@FeOOH/NF | 1.478 | 1.549 |

As observed in the table, most of the materials, when used for full water splitting, with better or worse performance than the as-synthesized material, are either composed of noble metals, are complex, or are not bifunctional catalysts.

### Example 7. Long-Term Stability for N—NiMo₃P

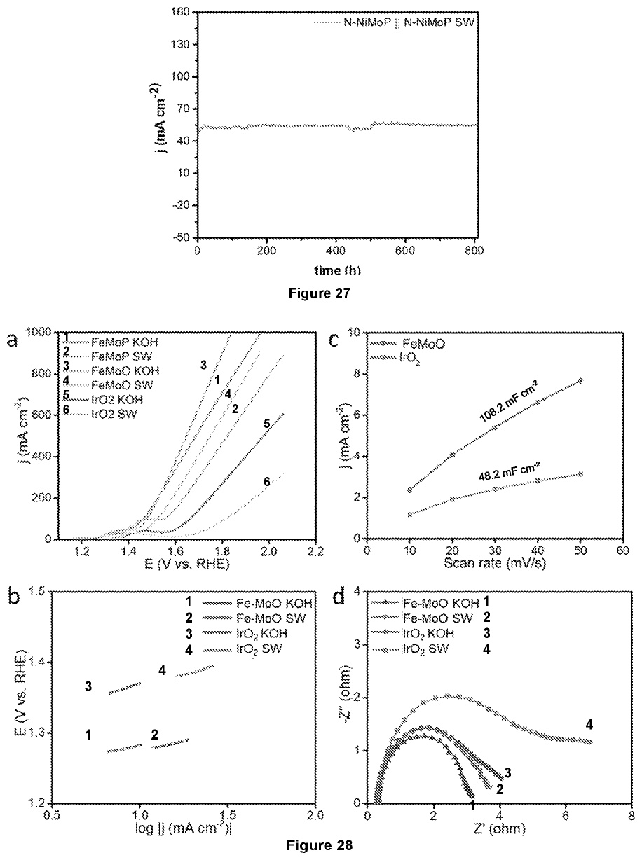

N—NiMoP was employed as a cathode and anode to test its stability for long-term operation in seawater, and it was found that the catalyst is stable over 800 h without any loss in current density (see FIG. 27).

### Example 8. FeMoP

The Ni foam in N—NiMo₃P in the above Example 1 was replaced by Fe foam while keeping all other parameters constant and using the same synthesis method. The resultant Fe—Mo oxide and Fe—Mo phosphide were then tested in a sample of 1 M KOH in deionised water, and in a sample of real seawater from Altona Beach, Melbourne, Victoria.

The Fe—Mo oxide catalyst performed exceptionally well in both the electrolytes as it achieved a current density of 100 mA cm⁻² at only 1.48 V and 1.52 V (OER), as did the Fe—Mo phosphide catalyst as it achieved a current density of 100 mA cm⁻² at only 1.46 V and 1.55 V (OER), while N—NiMo₃P required an 1.43 V and 1.58 V to achieve a current density of 10 mA cm⁻² in the 1M KOH and seawater samples, respectively (FIG. 28a).

Tafel plots (FIG. 28b) were further obtained to understand the reaction kinetics with FeMo oxide demonstrating low Tafel values of 49.2 and 56.9 mV dec⁻¹ while IrO₂ had Tafel values of 74.6 and 82.5 mV dec⁻¹ in 1 M KOH and real seawater, respectively showing that catalyst has superior kinetics over commercial IrO₂. To further analyze the electrochemically active area of the electrode that is accessible to the electrolyte, double layer capacitance (C_{dl}) was calculated showing that catalyst has more active surface area (108.2 mF cm⁻²) than commercial IrO₂ (48.2 mF cm⁻²) implying better transfer of charge (FIG. 28c).

This was further confirmed by using electrochemical impedance spectroscopy showing that the FeMo oxide (as well as FeMo phosphide) faced less electrolyte resistance than commercial IrO₂ in both 1 M KOH and real seawater, indicating faster mass transport and transfer of charge (FIG. 28d).

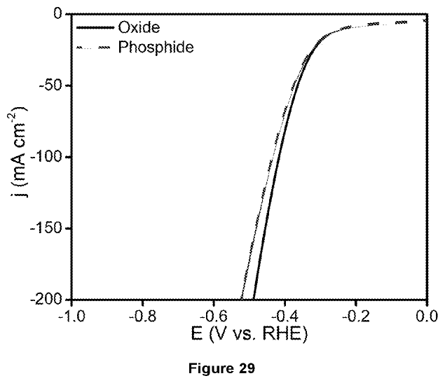

FeMo oxide was further tested for its HER performance and the LSV curves plotted in FIG. 29 show that it requires an overpotential of 238 mV to reach a current density of 10 mA cm⁻² in 1M sea water (SW). FeMo oxide was then phosphorised and used for electrochemical testing. The LSV curve shows that the FeMo phosphide required an overpotential of 234 mV to achieve 10 mA cm⁻² for HER, which is lower than the N—NiMo₃P catalyst. It was therefore concluded that Ni doping of the heteroatom-doped molybdenum phosphide resulted in exceptional HER and Fe doping of the heteroatom-doped molybdenum phosphide resulted in exceptional OER performance.

1. An electrocatalyst comprising at least one ultra-thin 2D defect rich porous sheet of a crystalline inorganic material which is a heteroatom doped-transition metal molybdenum phosphide, wherein
the transition metal is other than molybdenum, and
a plurality of pores and a plurality of other defects form active sites which are distributed laterally across the ultra-thin 2D porous sheet, that is, distributed between edges of the sheet.

2. The electrocatalyst of claim 1, wherein the inorganic material is polycrystalline comprising a plurality of crystallites having at least one grain boundary defect at interfaces between adjacent crystallites.

3. The electrocatalyst of claim 1, wherein each sheet has a basal plane which comprises the plurality of pores and the plurality of defects.

4. The electrocatalyst of claim 1, wherein pores and other defects are homogenously distributed throughout the sheet.

5. The electrocatalyst of claim 1, wherein pores in the sheet have pore edges which comprise electrochemically active dangling bond sites, and/or wherein edges of the sheet comprise electrochemically active dangling bond sites.

6. (canceled)

7. The electrocatalyst of claim 1, wherein the heteroatom doping occurs at grain boundaries, and the transition metal is inserted into a Mo core of the inorganic material.

8. The electrocatalyst of claim 1, wherein the transition metal molybdenum phosphide is heteroatom doped with an electron withdrawing heteroatom selected from one or more of: nitrogen, boron, sulfur, and phosphorus.

9. The electrocatalyst of claim 1, wherein the transition metal molybdenum phosphide is heteroatom doped with nitrogen and the electrocatalyst is nitrogen doped-transition metal-molybdenum phosphide.

10. The electrocatalyst of claim 1, wherein the transition metal is a first-row transition metal.

11. The electrocatalyst of claim 1, wherein the inorganic material comprises the transition metal in the (II) or (III) oxidation state.

12. The electrocatalyst of claim 1, wherein the inorganic material comprises a shield of one or more polyanions which repel negative anions from surfaces of the inorganic material, wherein the polyanions comprise one or more of: phosphate, nitrate and hydroxyl.

13. The electrocatalyst of claim 1, wherein the pores comprise one or more of:
micropores, of average pore diameter of from about 0.75 nm to about 1.20 nm; and
mesopores of average pore diameter of from about 2 nm to about 50 nm; and
a pore volume ranging from about 3.00×10⁻³ cm³ g⁻¹ to about 7.00×10⁻³ cm³ g⁻¹.

14. (canceled)

15. The electrocatalyst of claim 1, wherein the inorganic material has a surface area of greater than about 5.00 m² g⁻¹.

16. The electrocatalyst of claim 1, comprising at least one ultra-thin 2D defect rich porous sheet of a crystalline inorganic material which is a nitrogen doped-nickel molybdenum phosphide (N—NiMo₃P) or a nitrogen-doped-iron molybdenum phosphide.

17. The electrocatalyst of claim 16, wherein nickel or iron is present in amount of about 18% w/w of the inorganic material.

18. The electrocatalyst of claim 1, wherein the ultra-thin 2D defect rich porous sheet has a nanometer sized dimension in one direction and a micrometre sized dimension in a lateral direction.

19. The electrocatalyst of claim 1, wherein the inorganic material comprises molybdenum in a high oxidation state of Mo⁶⁺ and/or Mo⁴⁺.

20. The electrocatalyst of claim 1, wherein the inorganic material is oxide free.

21. (canceled)

22. (canceled)

23. (canceled)

24. An electrochemical cell comprising one or more of:
an anode comprising an electrocatalyst of claim 1, and
a cathode comprising an electrocatalyst of claim 1.

25. (canceled)

26. A method of synthesizing ultra-thin 2D defect rich porous sheets of a heteroatom doped-transition metal molybdenum phosphide, comprising the steps of:
combining a peroxomolybdic solution, a non-molybdenum transition metal foam, and with an organic source of heteroatoms to form a first reactant solution;
hydrothermally reacting the first reactant solution and recovering a dry solid powder product on completion of the hydrothermal reaction;
annealing the dry solid powder under an inert atmosphere to form an annealed powder material; and
phosphorizing the annealed powder material with a source of phosphorus under an inert atmosphere to from the ultra-thin 2D defect rich porous sheets of a heteroatom doped-transition metal molybdenum phosphide.
